(19) United States
(12) Patent Application Publication
(10) Pub. No.: US 2026/0031945 A1
(43) Pub. Date: Jan. 29, 2026

(54) LOW-RESOLUTION BEHAVIOR IN A RADIO NODE

(71) Applicant: Lenovo (Singapore) Pte Ltd, Singapore (SG)

(72) Inventors: Seyedomid Taghizadeh Motlagh, Oberursel (DE); Karthikeyan Ganesan, Kronberg Im Taunus (DE); Colin Frank, Park Ridge, IL (US); Ali Ramadan Ali, Kraiburg (DE)

(73) Assignee: Lenovo (Singapore) Pte Ltd, Singapore (SG)

(21) Appl. No.: 18/787,920

(22) Filed: Jul. 29, 2024

(51) Int. Cl. H04L 5/00; H04W 28/06; H04W 28/18

(52) U.S. Cl. CPC H04L 5/0048; H04W 28/06; H04W 28/18

(57) ABSTRACT

Various aspects of the present disclosure relate to low-resolution behavior in a radio node. An apparatus, such as a user equipment (UE) and/or network equipment, transmits first configuration information comprising one or more low-resolution receive behaviors of a first radio node, and receives second configuration information for reception of a modulated signal, wherein the second configuration information is based at least in part on the first configuration information. The apparatus receives, based at least in part on the second configuration information, the modulated signal comprising one or more of data or control information.

### TECHNICAL FIELD

The present disclosure relates to wireless communications, and more specifically to power conservation (e.g., reduction of power usage) in wireless communications systems.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements. In the present disclosure several terms and/or elements may be separated by a forward slash (/) which may represent additional or alternative implementations. For instance, the phrase “A/B/C” may be interpreted as “A, B, and/or C.”

Some implementations of the method and apparatuses described herein may include a UE for wireless communication to transmit first configuration information including one or more low-resolution receive behaviors of the UE; receive second configuration information for reception of a modulated signal, wherein the second configuration information is based at least in part on the first configuration information; and receive, based at least in part on the second configuration information, the modulated signal including one or more of data or control information. In implementations, the first configuration information can include capability information, such as capability information for low-resolution receive behaviors of the UE.

In some implementations of the method and apparatuses for a UE described herein, the one or more low-resolution receive behaviors of the UE are associated with a low resolution analog-to-digital converter (ADC) of the UE; the at least one processor is configured to cause the UE to: receive third configuration information for reception of a reference signal; and receive one or more first reference signals based at least in part on the third configuration information; the one or more first reference signals include one or more reference signal values indicated to be measurable at a receiver of the UE; the one or more first reference signals are defined at one or more of an input stage of an ADC of the UE or an output stage of the ADC of the UE; the third configuration information includes an indication of one or more of channel inversion or pre-equalization, and wherein the at least one processor is configured to cause the UE to determine whether the one or more of the channel inversion or the pre-equalization is executable within an indicated error measure; based at least in part on receiving the one or more first reference signals, the at least one processor is configured to cause the UE to one or more of: perform measurement of the one or more first reference signals; report the performed measurement; or transmit one or more second reference signals with one or more transmission parameters quasi-co-located with the one or more first reference signals.

In some implementations of the method and apparatuses for a UE described herein, the at least one processor is configured to cause the UE to one or more of: receive the third configuration information based at least in part on transmission of the first configuration information; or receive the third configuration information subsequent to transmission of the first configuration information; the third configuration information includes an indication of a predefined reference signal and an indication of one or more of a channel inversion or pre-equalization applied to the predefined reference signal; the third configuration information includes a definition of the one or more first reference signals in a time domain including an indication of a time-domain sequence of complex values at one or more of an input stage or an output stage of an ADC of the UE; the at least one processor is configured to cause the UE to one or more of: transmit an indication of a compatibility of the one or more first reference signals; adjust one or more parameters of the one or more first reference signals and report one or more adjusted parameters of the one or more first reference signals; or assume the one or more adjusted parameters of the one or more first reference signals in association with reporting the one or more adjusted parameters of the one or more first reference signals; the at least one processor is configured to cause the UE to adjust demodulation of the modulated signal received in association with the one or more first reference signals (for instance, the modulated data signal is indicated to be associated with or quasi-co-located (QCL) with as sharing the same antenna port, or as a QCL relation indicating the both transmissions including a channel inversion step and/or are defined at an input stage of the receiver ADC); the first configuration information includes one or more of: a baseband analog function computation capability indication associated with the UE; a programmable ADC resolution; or an association of the one or more low-resolution receive behaviors of the UE with one or more low-resolution transmit behaviors of the UE.

Some implementations of the method and apparatuses described herein may further include a processor for wireless communication to transmit first configuration information including one or more low-resolution receive behaviors of a first radio node; receive second configuration information for reception of a modulated signal, wherein the second configuration information is based at least in part on the first configuration information; and receive, based at least in part on the second configuration information, the modulated signal including one or more of data or control information. In implementations, the first configuration information can include capability information, such as capability information for low-resolution receive behaviors of the processor.

Some implementations of the method and apparatuses described herein may further include a processor for wireless communication to receive first configuration information including one or more low-resolution receive behaviors of a first radio node; transmit second configuration information for reception of a modulated signal, wherein the second configuration information is based at least in part on the first configuration information; and transmit, based at least in part on the second configuration information, the modulated signal including one or more of data or control information.

Some implementations of the method and apparatuses described herein may further include a method performed by a UE, the method including transmitting first configuration information including one or more low-resolution receive behaviors of the UE; receiving second configuration information for reception of a modulated signal, wherein the second configuration information is based at least in part on the first configuration information; and receiving, based at least in part on the second configuration information, the modulated signal including one or more of data or control information.

In some implementations of the method and apparatuses for a UE described herein, the one or more low-resolution receive behaviors of the UE are associated with a low resolution ADC of the UE; further including: receiving third configuration information for reception of a reference signal; and receiving one or more first reference signals based at least in part on the third configuration information; the one or more first reference signals include one or more reference signal values indicated to be measurable at a receiver of the UE; the one or more first reference signals are defined at one or more of an input stage of an ADC of the UE or an output stage of the ADC of the UE; the third configuration information includes an indication of one or more of channel inversion or pre-equalization, and wherein the method further includes determining whether the one or more of the channel inversion or the pre-equalization is executable within an indicated error measure; based at least in part on receiving the one or more first reference signals, the method further includes one or more of: performing measurement of the one or more first reference signals; reporting the performed measurement; or transmitting one or more second reference signals with one or more transmission parameters quasi-co-located with the one or more first reference signals.

In some implementations of the method and apparatuses described herein, the method further including one or more of: receiving the third configuration information based at least in part on transmission of the first configuration information; or receiving the third configuration information subsequent to transmission of the first configuration information; the third configuration information includes an indication of a predefined reference signal and an indication of one or more of a channel inversion or pre-equalization applied to the predefined reference signal; the third configuration information includes a definition of the one or more first reference signals in a time domain including an indication of a time-domain sequence of complex values at one or more of an input stage or an output stage of an ADC of the UE; further including one or more of: transmitting an indication of a compatibility of the one or more first reference signals; adjusting one or more parameters of the one or more first reference signals and report one or more adjusted parameters of the one or more first reference signals; or assuming the one or more adjusted parameters of the one or more first reference signals in association with reporting the one or more adjusted parameters of the one or more first reference signals; further including adjusting demodulation of the modulated signal received in association with the one or more first reference signals; the first configuration information includes one or more of: a baseband analog function computation capability indication associated with the UE; a programmable ADC resolution; or an association of the one or more low-resolution receive behaviors of the UE with one or more low-resolution transmit behaviors of the UE.

Some implementations of the method and apparatuses described herein may further include a method performed by a UE, the method including receiving first configuration information including one or more low-resolution receive behaviors of a first radio node; transmitting second configuration information for reception of a modulated signal, wherein the second configuration information is based at least in part on the first configuration information; and transmitting, based at least in part on the second configuration information, the modulated signal including one or more of data or control information.

In some implementations of the method and apparatuses described herein, the method further including modulating the modulated signal into a time-domain sequence of complex values based at least in part on one or more ADC steps supported by the first radio node; further including: transmitting third configuration information for reception of reference signal; and transmitting one or more first reference signals based at least in part on the third configuration information; the third configuration information includes an indication of one or more of channel inversion or pre-equalization applied at the UE; the one or more low-resolution receive behaviors of the first radio node are associated with a low resolution ADC of the first radio node.

Some implementations of the method and apparatuses described herein may further include a NE for wireless communication to transmit first configuration information including one or more low-resolution receive behaviors of the NE; receive second configuration information for reception of a modulated signal, wherein the second configuration information is based at least in part on the first configuration information; and receive, based at least in part on the second configuration information, the modulated signal including one or more of data or control information. In implementations, the first configuration information can include capability information, such as capability information for low-resolution receive behaviors of the NE.

In some implementations of the method and apparatuses described herein, the one or more low-resolution receive behaviors of the NE are associated with a low resolution ADC of the NE; the at least one processor is configured to cause the NE to: receive third configuration information for reception of a reference signal; and receive one or more first reference signals based at least in part on the third configuration information; the one or more first reference signals include one or more reference signal values indicated to be measurable at a receiver of the NE; the one or more first reference signals are defined at one or more of an input stage of an ADC of the NE or an output stage of the ADC of the NE; the third configuration information includes an indication of one or more of channel inversion or pre-equalization, and wherein the at least one processor is configured to cause the NE to determine whether the one or more of the channel inversion or the pre-equalization is executable within an indicated error measure; based at least in part on receiving the one or more first reference signals, the at least one processor is configured to cause the NE to one or more of: perform measurement of the one or more first reference signals; report the performed measurement; or transmit one or more second reference signals with one or more transmission parameters quasi-co-located with the one or more first reference signals; the at least one processor is configured to cause the NE to one or more of: receive the third configuration information based at least in part on transmission of the first configuration information; or receive the third configuration information subsequent to transmission of the first configuration information.

In some implementations of the method and apparatuses described herein, the third configuration information includes an indication of a predefined reference signal and an indication of one or more of a channel inversion or pre-equalization applied to the predefined reference signal; the third configuration information includes a definition of the one or more first reference signals in a time domain including an indication of a time-domain sequence of complex values at one or more of an input stage or an output stage of an ADC of the NE; the at least one processor is configured to cause the NE to one or more of: transmit an indication of a compatibility of the one or more first reference signals; adjust one or more parameters of the one or more first reference signals and report one or more adjusted parameters of the one or more first reference signals; or assume the one or more adjusted parameters of the one or more first reference signals in association with reporting the one or more adjusted parameters of the one or more first reference signals; the at least one processor is configured to cause the NE to adjust demodulation of the modulated signal received in association with the one or more first reference signals (for instance, the modulated data signal is indicated to be associated with or QCL-ed with as sharing the same antenna port, or as a QCL relation indicating the both transmissions including a channel inversion step and/or are defined at an input stage of the receiver ADC); the first configuration information includes one or more of: a baseband analog function computation capability indication associated with the NE; a programmable ADC resolution; or an association of the one or more low-resolution receive behaviors of the NE with one or more low-resolution transmit behaviors of the NE.

Some implementations of the method and apparatuses described herein may further include a NE for wireless communication to receive first configuration information including one or more low-resolution receive behaviors of a first radio node; transmit second configuration information for reception of a modulated signal, wherein the second configuration information is based at least in part on the first configuration information; and transmit, based at least in part on the second configuration information, the modulated signal including one or more of data or control information.

In some implementations of the method and apparatuses described herein, at least one processor is configured to cause the NE to modulate the modulated signal into a time-domain sequence of complex values based at least in part on one or more ADC steps supported by the first radio node; the at least one processor is configured to cause the NE to: transmit third configuration information for reception of reference signal; and transmit one or more first reference signals based at least in part on the third configuration information; the third configuration information includes an indication of one or more of channel inversion or pre-equalization applied at the NE; the one or more low-resolution receive behaviors of the first radio node are associated with a low resolution ADC of the first radio node.

Some implementations of the method and apparatuses described herein may further include a method performed by a NE, the method including transmitting first configuration information including one or more low-resolution receive behaviors of the NE; receiving second configuration information for reception of a modulated signal, wherein the second configuration information is based at least in part on the first configuration information; and receiving, based at least in part on the second configuration information, the modulated signal including one or more of data or control information.

In some implementations of the method and apparatuses for a NE described herein, the one or more low-resolution receive behaviors of the NE are associated with a low resolution ADC of the NE; further including: receiving third configuration information for reception of a reference signal; and receiving one or more first reference signals based at least in part on the third configuration information; the one or more first reference signals include one or more reference signal values indicated to be measurable at a receiver of the NE; the one or more first reference signals are defined at one or more of an input stage of an ADC of the NE or an output stage of the ADC of the NE; wherein the third configuration information includes an indication of one or more of channel inversion or pre-equalization, and wherein the method further includes determining whether the one or more of the channel inversion or the pre-equalization is executable within an indicated error measure; based at least in part on receiving the one or more first reference signals, the method further includes one or more of: performing measurement of the one or more first reference signals; reporting the performed measurement; or transmitting one or more second reference signals with one or more transmission parameters quasi-co-located with the one or more first reference signals.

In some implementations of the method and apparatuses for a NE described herein, the method further including one or more of: receiving the third configuration information based at least in part on transmission of the first configuration information; or receiving the third configuration information subsequent to transmission of the first configuration information; the third configuration information includes an indication of a predefined reference signal and an indication of one or more of a channel inversion or pre-equalization applied to the predefined reference signal; the third configuration information includes a definition of the one or more first reference signals in a time domain including an indication of a time-domain sequence of complex values at one or more of an input stage or an output stage of an ADC of the NE; further including one or more of: transmitting an indication of a compatibility of the one or more first reference signals; adjusting one or more parameters of the one or more first reference signals and report one or more adjusted parameters of the one or more first reference signals; or assuming the one or more adjusted parameters of the one or more first reference signals in association with reporting the one or more adjusted parameters of the one or more first reference signals; further including adjusting demodulation of the modulated signal received in association with the one or more first reference signals; the first configuration information includes one or more of: a baseband analog function computation capability indication associated with the NE; a programmable ADC resolution; or an association of the one or more low-resolution receive behaviors of the NE with one or more low-resolution transmit behaviors of the NE.

Some implementations of the method and apparatuses described herein may further include a method performed by a NE, the method including receiving first configuration information including one or more low-resolution receive behaviors of a first radio node; transmitting second configuration information for reception of a modulated signal, wherein the second configuration information is based at least in part on the first configuration information; and transmitting, based at least in part on the second configuration information, the modulated signal including one or more of data or control information.

In some implementations of the method and apparatuses described herein, the method further including modulating the modulated signal into a time-domain sequence of complex values based at least in part on one or more ADC steps supported by the first radio node; further including: transmitting third configuration information for reception of reference signal; and transmitting one or more first reference signals based at least in part on the third configuration information; the third configuration information includes an indication of one or more of channel inversion or pre-equalization applied at the NE; the one or more low-resolution receive behaviors of the NE are associated with a low resolution ADC of the NE.

### BRIEF DESCRIPTION OF THE DRAWINGS

FIG. 1 illustrates an example of a wireless communications system in accordance with aspects of the present disclosure.

FIG. 2 illustrates a scenario for EVM measurement points according to one or more implementations.

FIG. 3 illustrates an EVM calculation block diagram for 2-Layer uplink multiple input multiple output (MIMO) according to one or more implementations.

FIG. 4 illustrates an example wireless link diagram in accordance with aspects of the present disclosure.

FIG. 5 illustrates a signaling diagram in accordance with aspects of the present disclosure.

FIG. 6 illustrates a signaling diagram in accordance with aspects of the present disclosure.

FIG. 7 illustrates a time delay diagram in accordance with aspects of the present disclosure.

FIG. 8 illustrates an example scenario in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of a NE in accordance with aspects of the present disclosure.

FIG. 12 illustrates a flowchart of a method in accordance with aspects of the present disclosure.

FIG. 13 illustrates a flowchart of a method in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. Digital-to-analog converters (DACs) and ADCs are utilized at different nodes of a wireless communication system to enable wireless communication using time-frequency resources, including at the UE and NE. For instance, ADCs and DACs are used in the analog front-end (AFE) of transceivers to handle high-speed data conversion, enabling efficient transmission and reception of signals. Some ADCs and DACs are integrated into system-on-chip (SoC) designs for wireless transceivers and can support different frequency bands including sub-6 GHz (FR1) and millimeter-wave (FR2) frequency bands. ADCs and DACs, however, can account for a significant percentage of energy consumption at different nodes of a wireless communication system.

Due to a substantially lower complexity, cost, and energy consumption, low resolution (LR) DACs and ADCs show potential for reduced link energy consumption as well as to facilitate up-scaling of a number of digital chains, which can reduce the per-chain component cost. A LR ADC, for instance, represents an ADC that is configured to utilize much fewer quantization states/quantization bits, a lower supported error vector magnitude (EVM), and/or modulation error ratio (MER) than does a higher-resolution ADC. Further details regarding LR DACs/ADCs are presented below. For example, when link performance is not primarily based on quantization resolution (e.g., as in high resolution DAC/ADC scenarios), the utilization of a beam and/or radio chain with LR DAC and/or LR ADC can result in an improved energy efficiency. Nevertheless, realizing potential gains of LR radios may involve modifying steps associated with channel estimation of a wireless link associated with an LR radio, channel equalization of the link terminated at an LR radio, as well as link adaptation (e.g., transmit (Tx) power and modulation and coding scheme (MCS) adjustments for the link associated with a LR radio) in light of the non-linear LR quantization effect that may result from utilizing LR ADCs/DACs.

In particular, the impact of the quantization distortion caused by LR ADC can lead to an increased signal reception error due, at least in part, to erroneous demodulation of data symbols, channel estimation, and channel equalization. The defined downlink (DL), uplink (UL), and sidelink (SL) demodulation reference signal (DMRS) transmission and processes (e.g., in 3GPP technical specification (TS) 38.211) can lead to a distorted channel equalization when processed by an LR receiver, as the DMRS symbols (e.g., of DL physical downlink shared channel (PDSCH)) as currently defined need to be received and processed prior to channel equalization.

Aspects of the present disclosure are described in the context of a wireless communications system and consider a wireless communication link between two radio nodes including at least a LR receiver including a low-resolution ADC, and techniques for data/information modulation and channel equalization such that the receiver (e.g., ADC) quantization distortion can be mitigated.

For example, implementations describe communication (e.g., transmission) of an LR reception behavior of a radio node, e.g., a LR DAC. Further, techniques are described for modulation/mapping of a Tx data/control information into a signal with time-domain complex values with a constellation (e.g., set of possible complex values for each sample of an analog signal) according to an indicated LR behavior of an ADC. For instance, a Tx constellation can be configured according to the supported ADC complex steps of an LR receiver and indications can be provided for a channel inversion/Tx pre-equalization step for an LR receiver radio node. Implementations also provide solutions for configuration/reception/measurement of a reference signal (RS) defined as an expected received signal at the input of the ADC of an LR radio node.

By performing the described techniques, devices in a wireless communications system can utilize LR radios (e.g., LR ADCs/DACs) for wireless communication while minimizing effects of LR radio utilization on signal quality. Thus, energy usage can be reduced while mitigating effects of such energy conservation on signal quality.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

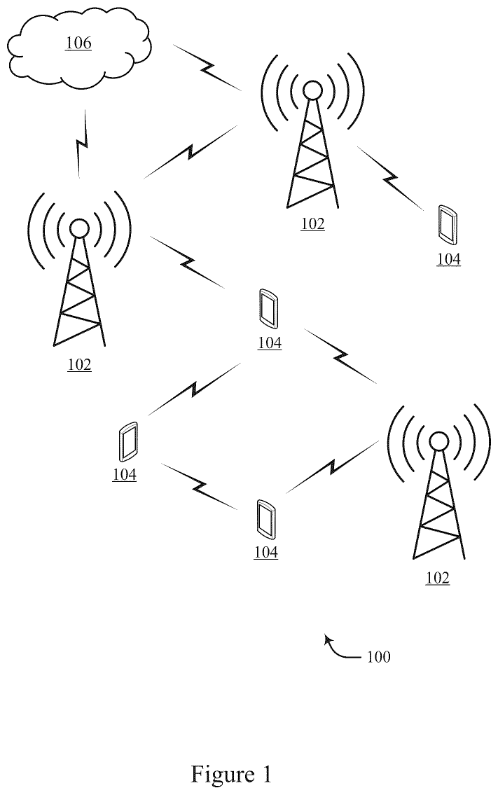

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. #Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. An NE 102 and/or a UE 104, for instance, can be referred to as a first radio node and/or a second radio node, or vice-versa. According to implementations, a first radio node can transmit first configuration information including one or more low-resolution receive behaviors of the first radio node and the first radio node can receive second configuration information for reception of a modulated signal, where the second configuration information can be based at least in part on the first configuration information. The first radio node can receive, based at least in part on the second configuration information, the modulated signal comprising one or more of data or control information.

Further, a second radio node can receive the first configuration information including one or more low-resolution receive behaviors of a first radio node and transmit second configuration information for reception of a modulated signal, where the second configuration information can be based at least in part on the first configuration information. The second radio node can transmit, based at least in part on the second configuration information, the modulated signal comprising one or more of data or control information.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to sounding reference signal (SRS), an SRS resource can be configured by the SRS-Resource information element (IE) or the SRS-PosResource IE and consists of:

$${N}_{ap}^{SRS} ∈ \{ 1 , 2 , 4 \}$$

antenna ports

$${\{ {p}_{i} \}}_{i = 0}^{{N}_{ap}^{SRS} - 1} ,$$

where the number of antenna ports is given by the higher layer parameter nrofSRS-Ports if configured, otherwise

$${N}_{ap}^{SRS} = 1 , and {p}_{i} = 1000 + i$$

when the SRS resource is in a SRS resource set with higher-layer parameter usage in SRS-ResourceSet not set to ‘nonCodebook’, or determined according to [TS 38.214] when the SRS resource is in a SRS resource set with higher-layer parameter usage in SRS-ResourceSet set to ‘nonCodebook’

$${N}_{s y m b}^{SRS} ∈ \{ 1 , 2 , 4 , 8 , 10 , 12 , 14 \}$$

consecutive OFDM symbols given by the field nrofSymbols contained in the higher layer parameter resourceMapping
l₀, the starting position in the time domain given by

$${l}_{0} = {N}_{s y m b}^{slot} - 1 - {l}_{offset}$$

where the offset l_{offset}∈{0, 1, . . . , 13} counts symbols backwards from the end of the slot and is given by the field startPosition contained in the higher layer parameter resourceMapping and

$${l}_{offset} \geq {N}_{s y m b}^{SRS} - 1$$

k₀, the frequency-domain starting position of the SRS

The SRS sequence for an SRS resource can be generated according to

$${r}^{( {p}_{i} )} ( n , {l}^{′} ) = {r}_{u , v}^{( {a}_{i} , δ )} ( n )$$

$$0 \leq n \leq {M}_{sc , b}^{SRS} - 1$$

$${l}^{′} ∈ \{ 0 , 1 , … , {N}_{s y m b}^{SRS} - 1 \}$$

where

$${M}_{sc , b}^{SRS}$$

is given by TS 38.101-1 clause 6.4.1.4.3,

$${r}_{u , v}^{( a , δ )} ( n )$$

is given by TS 38.101-1 clause 5.2.2 with δ=log, (K_{TC}) and the transmission comb number K_{TC}∈{2, 4, 8} is contained in the higher-layer parameter transmissionComb. The cyclic shift αᵢ for antenna port pᵢ is given as

$${α}_{i} = 2 π \frac{{n}_{SRS}^{cs , i}}{{n}_{SRS}^{cs , max}}$$

$${n}_{SRS}^{cs , i} = \{ \begin{matrix}( {n}_{SRS}^{cs} + \frac{{n}_{SRS}^{cs , max} ⌊ ( {p}_{i} − 1000 ) / 2 ⌋}{{N}_{ap}^{SRS} / 2} ) \text{} mod \text{} {n}_{SRS}^{cs , max} & \text{if} {N}_{ap}^{SRS} = 4 and {n}_{SRS}^{cs , max} = 6 \\ ( {n}_{SRS}^{cs} + \frac{{n}_{SRS}^{cs , max} ( {p}_{i} − 1000 )}{{N}_{ap}^{SRS}} ) \text{} mod \text{} {n}_{SRS}^{cs , max} & otherwise\end{matrix} ,$$

$$where$$

$${n}_{SRS}^{cs} ∈ \{ 0 , 1 , … , {n}_{SRS}^{cs , max} - 1 \}$$

is contained in the higher layer parameter transmissionComb. The maximum number of cyclic shifts

$${n}_{SRS}^{cs , max}$$

are given by Table 1 (below).

The sequence group

$$u = ( {f}_{gh} ( {n}_{s , f}^{μ} , {l}^{′} ) + {n}_{ID}^{S R S} ) mod 30$$

and the sequence number v in TS 38.101-1 clause 5.2.2 depends on the higher-layer parameter groupOrSequenceHopping in the SRS-Resource IE or the SRS-PosResource IE. The SRS sequence identity

$${n}_{ID}^{SRS}$$

is given by the higher layer parameter sequenceId in the SRS-Resource IE, in which case

$${n}_{ID}^{SRS} ∈ \{ 0 , 1 , … , 1023 \} ,$$

or the SRS-PosResource-r16 IE, in which case

$${n}_{ID}^{SRS} ∈ \{ 0 , 1 , … , 65535 \} .$$

The quantity

$${l}^{′} ∈ \{ 0 , 1 , … , {N}_{s y m b}^{SRS} - 1 \}$$

is the OFDM symbol number within the SRS resource.

If groupOrSequenceHopping equals ‘neither’, neither group, nor sequence hopping can be used and

$${f}_{gh} ( {n}_{s , f}^{μ} , {l}^{′} ) = 0$$

$$v = 0$$

If groupOrSequenceHopping equals ‘groupHopping’, group hopping but not sequence hopping can be used and

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) {2}^{m} ) mod 30$$

$$v = 0$$

where the pseudo-random sequence c(i) is defined by TS 38.101-1 clause 5.2.1 and can be initialized with

$${c}_{i n i t} = {n}_{ID}^{S R S}$$

at the beginning of each radio frame.

TABLE 1
$Maximum number of cyclic shifts {n}_{SRS}^{cs , max} as a function of {K}_{TC} .$

| K_{TC} | ${n}_{SRS}^{cs , max}$ |
|---|---|
| 2 | 8 |
| 4 | 12 |
| 8 | 6 |

Regarding mapping to physical resources, when SRS is transmitted on a given SRS resource, the sequence r^{(p}^{ᵢ}⁾(n, l′) for each OFDM symbol l′ and for each of the antenna ports of the SRS resource can be multiplied with the amplitude scaling factor β_{SRS} in order to conform to the transmit power specified in [TS 38.213] and mapped in sequence starting with r^{(p}^{ᵢ}⁾(0,l′) to resource elements (k,l) in a slot for each of the antenna ports p; according to

$${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{ap}}} {β}_{SRS} {r}^{( {p}_{i} )} ( {k}^{′} , {l}^{′} ) & {k}^{′} = 0 , 1 , … , {M}_{sc , b}^{SRS} − 1 {l}^{′} = 0 , 1 , … , {N}_{symb}^{SRS} − 1 \\ 0 & otherwise\end{matrix}$$

The length of the SRS sequence is given by

$${M}_{sc , b}^{S R S} = {m}_{S R S , b} {N}_{s c}^{R B} / ( {K}_{T C} {P}_{F} )$$

where m_{SRS,b} is given by a selected row of Table 6.4.1.4.3-1 of TS 38.101-1 with b=B_{SRS} where B_{SRS}∈{0, 1, 2, 3} is given by the field b-SRS contained in the higher-layer parameter freqHopping if configured, otherwise B_{SRS}=0. The row of the table is selected according to the index C_{SRS}∈{0, 1, . . . , 63} given by the field c-SRS contained in the higher-layer parameter freqHopping. The quantity P_{F}∈{2, 4} is given by the higher-layer parameter FreqScalingFactor if configured, otherwise P_{F}=1. When FreqScalingFactor is configured, the UE expects the length of the SRS sequence to be a multiple of 6.

The frequency-domain starting position

$${k}_{0}^{( {p}_{i} )}$$

is defined by

$${k}_{0}^{( {p}_{i} )} = {\overline{k}}_{0}^{( {p}_{i} )} + {n}_{offset}^{FH} + {n}_{offset}^{RPFS}$$

$$where$$

$${\overline{k}}_{0}^{( {p}_{i} )} = {n}_{shift} {N}_{s c}^{R B} + ( {k}_{T C}^{( {p}_{i} )} + {k}_{offset}^{{l}^{′}} ) mod {K}_{T C}$$

$${k}_{TC}^{( {p}_{i} )} = \{ \begin{matrix}( {\overline{k}}_{TC} + {K}_{TC} / 2 ) \text{} mod \text{} {K}_{TC} & if {N}_{ap}^{SRS} = 4 , {p}_{i} ∈ \{ 1001 , 1003 \} , and {n}_{SRS}^{cs , max} = 6 \\ ( {\overline{k}}_{TC} + {K}_{TC} / 2 ) \text{} mod \text{} {K}_{TC} & \begin{matrix}if {N}_{ap}^{SRS} = 4 , {p}_{i} ∈ \{ 1001 , 1003 \} , and \\ {n}_{SRS}^{cs} ∈ \{ {n}_{SRS}^{cs , max} / 2 , … , {n}_{SRS}^{cs , max} − 1 \}\end{matrix} \\ {\overline{k}}_{TC} & otherwise\end{matrix}$$

$${n}_{offset}^{F H} = {\sum }_{b = 0}^{{B}_{SRS}} {m}_{SRS , b} {N}_{s c}^{R B} {n}_{b}$$

$${n}_{offset}^{RPFS} = {N}_{S C}^{R B} {m}_{SRS , {B}_{SRS}} ( ( {k}_{F} + {k}_{hop} ) mod {P}_{F} ) / {P}_{F}$$

and
k_{F}∈{0, 1, . . . , P_{F}−1} is given by the higher-layer parameter StartRBIndex if configured, otherwise k_{F}=0;
kₕₒₚ is given by Table 6.4.1.4.3-3 of TS 38.101-1 with

$${\overline{k}}_{hop} = ⌊ \frac{{n}_{SRS}}{{\prod }_{{b}^{′} = {b}_{hop}}^{{B}_{SRS}} {N}_{{b}^{′}}} ⌋ mod {P}_{F}$$

$${N}_{{b}_{hop}} = 1$$

if the higher-layer parameter EnableStartRBHopping is configured, otherwise kₕₒₚ=0.

If

$${N}_{BWP}^{start} \leq {n}_{shift}$$

the reference point for

$${k}_{0}^{( {p}_{i} )} = 0$$

is subcarrier 0 in common resource block 0, otherwise the reference point is the lowest subcarrier of the bandwidth part (BWP). If the SRS is configured by the IE SRS-PosResource, the quantity

$${k}_{offset}^{{l}^{′}}$$

is given by Table 6.4.1.4.3-2 of TS 38.101-1, otherwise

$${k}_{offset}^{{l}^{′}} = 0 .$$

The frequency domain shift value n_{shift} adjusts the SRS allocation with respect to the reference point grid and is contained in the higher-layer parameter freqDomainShift in the SRS-Resource IE or the SRS-PosResource IE. The transmission comb offset k̅_{TC}∈{0, 1, . . . , K_{TC}−1} is contained in the higher-layer parameter transmissionComb in the SRS-Resource IE or the SRS-PosResource IE and ng is a frequency position index.

Frequency hopping of the SRS is configured by the parameter bₕₒₚ∈{0, 1, 2, 3}, given by the field b-hop contained in the higher-layer parameter freqHopping if configured, otherwise bₕₒₚ=0. If bₕₒₚ≥B_{SRS}, frequency hopping is disabled and the frequency position index ng remains constant (unless re-configured) and is defined by

$${n}_{b} = ⌊ 4 {n}_{R R C} / {m}_{SRS , b} ⌋ mod {N}_{b}$$

for all

$${N}_{symb}^{SRS}$$

OFDM symbols of the SRS resource. The quantity n_{RRC} is given by the higher-layer parameter freqDomainPosition if configured, otherwise n_{RRC}=0, and the values of m_{SRS,b} and N_{b} for b=B_{SRS} are given by the selected row of Table 6.4.1.4.3-1 of TS 38.101-1 corresponding to the configured value of C_{SRS}.

If bₕₒₚ<B_{SRS}, frequency hopping is enabled and the frequency position indices n_{b} are defined by

$${n}_{b} = \{ \begin{matrix}⌊ 4 {n}_{RRC} / {m}_{SRS , b} ⌋ \text{} mod \text{} {N}_{b} & b \leq {b}_{hop} \\ ( {F}_{b} ( {n}_{SRS} ) + ⌊ 4 {n}_{RRC} / {m}_{SRS , b} ⌋ ) \text{} mod \text{} {N}_{b} & otherwise\end{matrix}$$

where N_{b} is given by Table 6.4.1.4.3-1 of TS 38.101-1,

$${F}_{b} ( {n}_{S R S} ) = \{ ( {N}_{b} / 2 ) \begin{matrix}⌊ \frac{{n}_{S R S} mod {Π}_{{b}^{′} = {b}_{hop}}^{b} {N}_{{b}^{′}}}{{Π}_{{b}^{′} = {b}_{hop}}^{b - 1} {N}_{{b}^{′}}} ⌋ + & if {N}_{b} even & \\ ⌊ \frac{{n}_{S R S} mod {Π}_{{b}^{′} = {b}_{hop}}^{b} {N}_{{b}^{′}}}{2 Π {}_{{b}^{′} = {b}_{hop}}^{b - 1} {N}_{{b}^{′}}} ⌋ & & \\ ⌊ {N}_{b} / 2 ⌋ ⌊ {n}_{SRS} / {Π}_{{b}^{′} = {b}_{hop}}^{b - 1} {N}_{{b}^{′}} ⌋ & if {N}_{b} odd & \end{matrix}$$

and where N_{b}_{ₕₒₚ}=1 regardless of the value of N_{b}. The quantity n_{SRS} counts the number of SRS transmissions. For the case of an SRS resource configured as aperiodic by the higher-layer parameter resourceType, it is given by n_{SRS}=└l′/R┘ within the slot in which the

$${N}_{s y m b}^{S R S}$$

symbol SRS resource is transmitted. The quantity

$$R \leq {N}_{s y m b}^{S R S}$$

is the repetition factor given by the field repetitionFactor if configured, otherwise

$$R = {N}_{symb}^{S R S} .$$

For the case of an SRS resource configured as periodic or semi-persistent by the higher-layer parameter resourceType, the SRS counter is given by

$${n}_{SRS} = ( \frac{N {}_{slot}^{frame , μ} {n}_{f} + n {}_{s , f}^{μ} - {T}_{offset}}{{T}_{SRS}} ) \cdot ( \frac{N {}_{symb}^{SRS}}{R} ) + ⌊ \frac{R}{} ⌋$$

for slots that satisfy

$$( + {n}_{s , f}^{μ} - {T}_{offset} ) {mod}_{{T}_{S R S}} = 0.$$

The periodicity T_{SRS} in slots and slot offset T_{offset} are given in clause 6.4.1.4.4 of TS 38.101-1.

EVM is a measure of the difference between the reference waveform and the measured waveform. This difference is called the error vector. Before calculating the EVM the measured waveform is corrected by the sample timing offset and radio frequency (RF) frequency offset. Then the carrier leakage can be removed from the measured waveform before calculating the EVM.

The measured waveform is further equalized using the channel estimates subjected to the EVM equalizer spectrum flatness requirement specified in clause 6.4.2.4 of TS 38.101-1. For Discrete Fourier Transform-spread-Orthogonal Frequency Division Multiplexing (DFT-s-OFDM) waveforms, the EVM result is defined after the front-end Fast Fourier Transform (FFT) and Inverse Discrete Fourier Transformation (IDFT) as the square root of the ratio of the mean error vector power to the mean reference power expressed as a percentage. For cyclic prefix (CP)-OFDM waveforms, the EVM result is defined after the front-end FFT as the square root of the ratio of the mean error vector power to the mean reference power expressed as a percentage.

The basic EVM measurement interval in the time domain is one preamble sequence for the physical random access channel (PRACH) and one slot for physical uplink control channel (PUCCH) and physical uplink shared channel (PUSCH) in the time domain. The EVM measurement interval is reduced by any symbols that contains an allowable power transient in the measurement interval, as defined in clause 6.3.3 of TS 38.101-1. The root mean square (RMS) average of the basic EVM measurements over 10 subframes for the average EVM case, and over 60 subframes for the RS EVM case, for the different modulation schemes cannot exceed the values specified in Table 2 below for the parameters defined in Table 3 below. For EVM evaluation purposes, all 13 PRACH preamble formats and all 5 PUCCH formats are considered to have the same EVM requirement as quadrature phase shift keying (QPSK) modulated.

TABLE 2
Requirements for Error Vector Magnitude

| Parameter | Unit | Average EVM Level |
|---|---|---|
| Pi/2-BPSK | % | 30 |
| QPSK | % | 17.5 |
| 16 QAM | % | 12.5 |
| 64 QAM | % | 8 |
| 256 QAM | % | 3.5 |

TABLE 3
Parameters for Error Vector Magnitude

| Parameter | Unit | Level |
|---|---|---|
| UE Output Power | dBm | ³ Table 6.3.1-1 of TS |
| | | 38.101-1 |
| UE Output Power for 256 | dBm | ³ Table 6.3.1-1 + 10 dB |
| QAM | | of TS 38.101-1 |

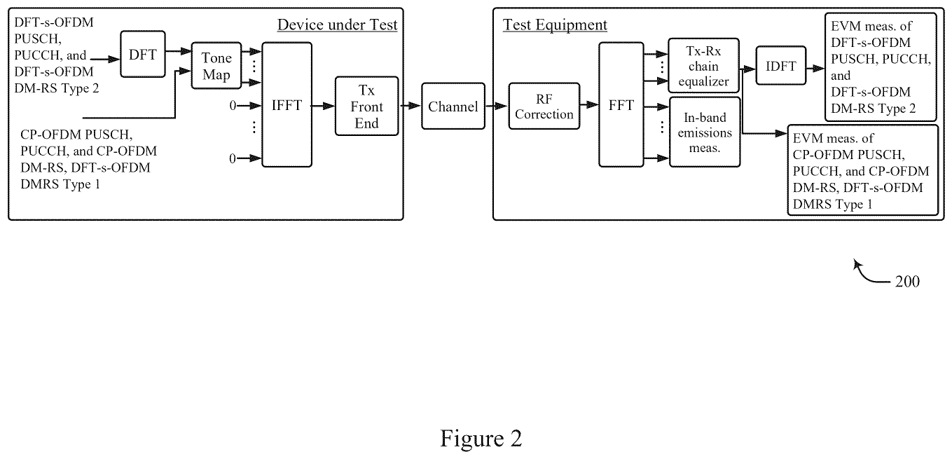

FIG. 2 illustrates a scenario 200 for EVM measurement points according to one or more implementations. The scenario 200 includes a device under test, a test equipment (TE), and shows a measurement point for the unwanted emission falling into non-allocated resource blocks (RB(s)) and the EVM for the allocated RB(s).

For UE with multiple transmission antennas, if UE indicates IE txDiversity-r16, EVM is measured at each antenna connector to get EVMᵢ, and the total EVM is calculated by values of EVMᵢ with weighting factor of linear power at each antenna connector.

$$E V M = \frac{{\sum }_{i = 1}^{k} {P}_{i} * {EVM}_{i}}{{\sum }_{i = 1}^{k} {P}_{i}}$$

where k=2, 4, and Pᵢ denotes the linear power measured at each antenna connector respectively.

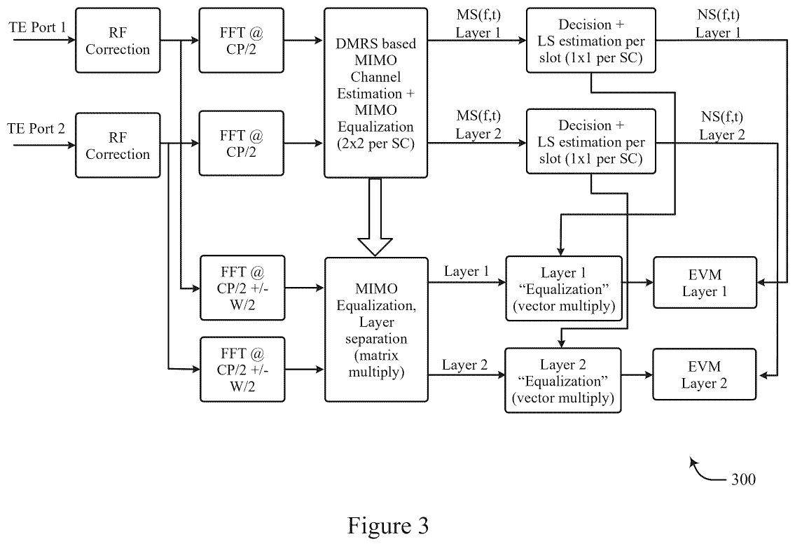

FIG. 3 illustrates an EVM calculation block diagram 300 for 2-Layer uplink multiple input multiple output (MIMO) according to one or more implementations. EVM for UL MIMO is measured per layer. A zero-forcing (ZF) MIMO receiver architecture is used so that dual layer transmissions by the UE can be demodulated by the test equipment receiver. In the block diagram 300 the TE receives signals from 2 different ports which are connected to two antenna connectors in the test system. For UL MIMO measurements a MIMO equalization step is performed to separate the layers. Each layer is then processed to receive the measurement results for each individual layer.

MIMO equalization can be based on RSs (DMRS) without using any data symbols. For the equalization process all available DMRS symbols can be used. The effective 2×2 channel matrix is estimated using RSs of different subcarriers, e.g. in case of DMRS antenna ports 0 and 2. In case that same subcarriers are used, e.g. DMRS antenna ports 0 and 1, a channel decomposition is necessary taking advantage of the orthogonal codes w_{f} and wₜ and assuming identical channel coefficients for adjacent subcarriers of same code division multiplexing (CDM) group.

Effective channel including the precoding matrix P is:

$$\tilde{H} = HP = [ \begin{matrix}{\tilde{h}}_{0 , 0} & {\tilde{h}}_{0 , 1} \\ {\tilde{h}}_{1 , 0} & {\tilde{h}}_{1 , 1}\end{matrix} ]$$

$$with$$

$${\tilde{h}}_{n , v} = \frac{{y}_{n} {r}_{v}^{*}}{\vert {r}_{v} {\vert}^{2}}$$

where y denotes the received symbol on port index n and r the RS for layer index v.

Since RSs of a specific layer are transmitted only on subcarriers of one CDM group channel, interpolation can be needed in order to obtain channel coefficients for all subcarriers. Channel interpolation can be done using the channel coefficients of active CDM group in all other CDM groups. The channel coefficients used to calculate the equalizer coefficients are obtained after channel smoothing in frequency domain by computing the moving average of interpolated channel coefficients. The moving average window size can be 7. For subcarriers at or near the edge of allocation the window size can be reduced accordingly.

The ZF equalizer coefficients are calculated as the inverse of the effective channel matrix:

$${G}_{Z F} = {\tilde{H}}^{- 1}$$

After performing the MIMO equalization each layer is processed using the existing procedure as defined in Annex E of TS 38.521-1. Since the channel estimation is calculated only on the DMRS symbols, an averaging including all 14 symbols of one slot, e.g. data and RSs, is needed in order to minimize EVM. The averaging is achieved by the least square (LS) equalization method described for single layer in Annex E.3. of TS 38.521-1.

MS(f,t) and NS(f,t) are processed with a LS estimator, to derive one equalizer coefficient per time slot and per allocated subcarrier. EC(f) is defined for each layer as:

$${EC}_{v} ( f ) = \frac{\sum {}_{t = 0}^{13} {NS}_{v} ( f , t ) * {NS}_{v} ( f , t )}{\sum {}_{t = 0}^{13} {MS}_{v} ( f , t ) * {NS}_{v} ( f , t )}$$

With * denoting complex conjugation. EC(f) are used to equalize layer data symbols.

EVM equalizer spectral flatness is derived from equalizer coefficients for each layer as follows:

$${c}_{v} = \vert {EC}_{v} ( f ) \vert \sqrt{{\vert {g}_{v , 0} \vert}^{2} + {\vert {g}_{v , 1} \vert}^{2}}$$

Aspects of the present disclosure include solutions to reduce quantization distortion, such as scenarios where a receiver device is using a LR transceiver. In the discussion herein, let [symbol] _{ADC} be the supported set of discrete complex values of an ADC at an LR receiver. Moreover, let s, ŝ denote the time-domain representations of the transmitted and received baseband signals respectively after modulation (e.g., according to a CP-OFDM waveform) and prior to demodulation and P_{TX}, P_{RX} denote the transmitter and receiver beamformer/spatial filer (e.g., an array of analog beamformer phase shifts). The received signal prior to demodulation can be expressed as

$$\begin{matrix}\hat{s} ( t ) = {E}_{RX} ( t , τ ) ⊗ \{ [ P {}_{RX}^{H} H ( t , τ ) {P}_{TX} ] ⊗ s ( t ) \} \\ = {E}_{RX} ( t , τ ) ⊗ \{ [ P {}_{RX}^{H} H ( t , τ ) {P}_{TX} ] ⊗ s ( t ) + q ( t ) \}\end{matrix}$$

where E_{RX} is the time-domain representation of the channel equalizer function at the receiver.

Alternatively, when channel equalization is performed at the transmitter and adjusted to the supported discrete steps of the receiver (Rx) ADC, the time-domain representation of the signal prior to de-modulation can be expressed as

$$\begin{matrix}\hat{s} ( t ) = \{ [ P {}_{RX}^{H} H ( t , τ ) {P}_{TX} ] ⊗ {E}_{TX} ( t , τ ) ⊗ s ( t ) \} \\ = [ P {}_{RX}^{H} H ( t , τ ) {P}_{TX} ] ⊗ {E}_{TX} ( t , τ ) ⊗ s ( t ) {=}^{△} y ( t ) ∈ {𝒟}_{ADC}\end{matrix}$$

where E_{TX} is the time-domain representation of the channel equalizer function at the transmitter.

Alternatively, when channel equalization is performed at the transmitter and adjusted to the supported discrete steps of the Rx ADC, the time-domain representation of the signal prior to de-modulation can be expressed as

$$\begin{matrix}\hat{s} ( t ) = \{ [ P {}_{RX}^{H} H ( t , τ ) {P}_{TX} ] ⊗ {E}_{TX} ( t , τ ) ⊗ s ( t ) \} \\ = [ P {}_{RX}^{H} H ( t , τ ) {P}_{TX} ] ⊗ {E}_{TX} ( t , τ ) ⊗ s ( t ) {=}^{△} y ( t ) ∈ {𝒟}_{ADC}\end{matrix}$$

where E_{TX} is the time-domain representation of the channel equalizer function at the transmitter.

According to the above, when channel state information (CSI) is available at the transmitter, the utilization and adjustment of transmitter-side equalizer such that y∈ [symbol] _{ADC} removes the impact of quantization distortion at the receiver given an asymptotically negligible thermal noise condition. Hence, as a high-level solution, for a transmission by a high resolution (HR) radio and reception by an LR radio at least including an LR ADC, channel equalization can be performed at the Tx side where the received analog baseband time-domain samples (prior to the Rx ADC) are adjusted, via a pre-equalization function at the transmitter, to be at the supported ADC quantization step.

Implementations discussed herein include examples of different aspects for the enhanced Tx-Rx processing steps for a physical wireless channel with an LR radio receiver. In the discussion herein it is understood that this disclosure is not limited to the single implementation and/or implementation elements individually, and one or more elements from one or more implementations may be combined to construct a new implementation. It is understood that description of the DAC/ADC of a radio chain and the associated quantization/conversion operation may include quantization/conversion operation of the real/in-phase part of the complex baseband signal and quantization/conversion operation of imaginary/quadrature part of the complex baseband signal implemented via separate ADC/DACs for the real and imaginary parts or implemented jointly for the real and imaginary parts (e.g., by quantizing separately the amplitude and phase of a complex valued sample). As such, when applicable, a reference within the following implementation/examples to the quantization or ADC/DAC operation may be understood to describe the equivalent quantization/DAC/ADC operation where an input complex-valued sample is mapped into a complex output value, and where the separate operations of the DACs (e.g., of the real and imaginary parts or of the amplitude and phase parts) are considered implicit to the overall/equivalent DAC or quantization operation.

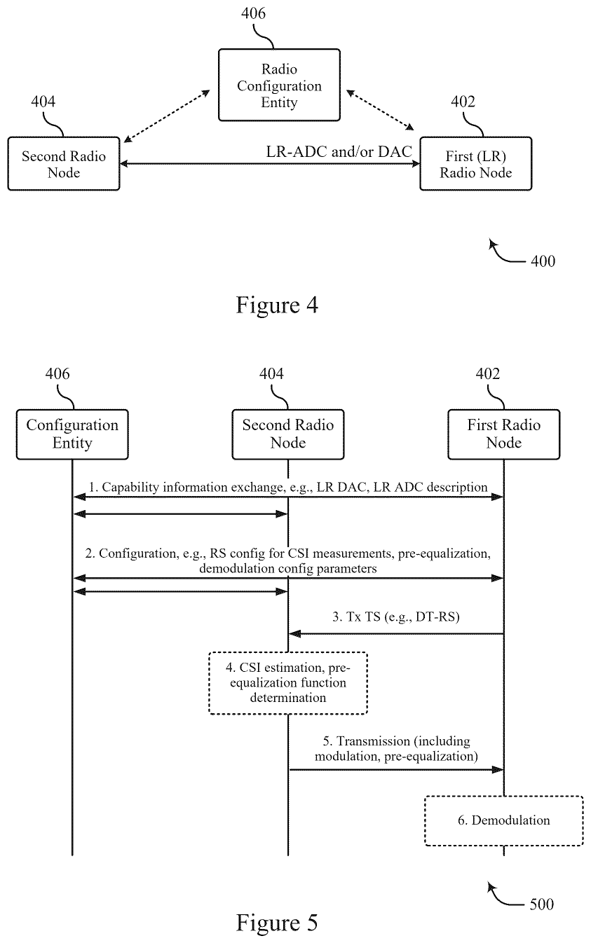

FIG. 4 illustrates an example wireless link diagram 400 in accordance with aspects of the present disclosure. The diagram 400 includes a first radio node 402, a second radio node 404, and a radio configuration entity 406. In the diagram 400 wireless communication can occur between the first radio node 402 and the second radio node 404, and the radio configuration entity 406 can configure radio behavior of the first radio node 402 and the second radio node 404, e.g., by collecting capability information of the radio nodes and defining and scheduling of RS transmission and measurement/reporting.

In implementations the first radio node 402 may be equipped with a LR ADC (and potentially an LR DAC) and the second radio node 404 may be equipped with an HR DAC and/or ADCs. A high/low resolution condition of an ADC/DAC may be associated with (at least in part) supported number of quantization states or bits being above/below a threshold. For instance, a DAC with less than 7 quantization bits and ADC with less than 8 quantization bits may be referred to as an LR DAC/ADC. Further, a radio chain equipped with an LR DAC and/or ADC may be referred to as an LR radio/chain and/or with a required level of the supported EVM, maximum achievable Tx or Rx, maximum achievable signal-to-noise ratio (SNR) associated with the ADC or DAC distortion, or MER at the Tx or Rx due to the impact of quantization distortion. In one example, a Tx/Rx chain with (maximum Rx) SNR or MER of less than 30 dB due to the impact of DAC/ADC quantization may be associated with an LR condition. In another example, a Tx/Rx chain with (maximum Rx) SNR or MER of more than 30 dB due to the impact of DAC/ADC quantization may be associated with an HR condition.

In some examples of the diagram 400 including the first radio node 402, the second radio node 404, and the configuration entity 406: (1) the first radio node 402 can be a NE (e.g., gNB/RAN node) and the second radio node 404 can be a UE, where the radio configuration entity 406 can be co-located at the first radio node 402 (e.g., UL reception via an LR gNB ADC); (2) the first radio node 402 can be a UE node and the second radio node 404 can be a NE, where the radio configuration entity 406 can be co-located at the second radio node 404 (e.g., DL reception via an LR UE ADC); (3) the first radio node 402 can be a UE and the second radio node 404 can be a UE. In some such examples, the radio configuration entity 406 can be co-located at the second radio node 404, at the first radio node 402, or at a third node, e.g., a NE associated with the first and/or second UE device (e.g., SL reception via an LR UE ADC); (4) the first radio node 402 can be a TRP/gNB/NE/RAN node and the second radio node 404 can be a NE/gNB/TRP node, where the radio configuration entity 406 can be co-located at the first radio node 402, second radio node 404, or at a third entity, e.g., a location or sensing management function residing in RAN or at the core network, LMF, or system function residing at the core or RAN.

In implementations, the second radio node 404 can perform one or more of: (1) estimation/determination/prediction of the wireless channel between the first radio node 402 and the second radio node 404, e.g., based on reception of a configured first RS from the first radio node; (2) determining/computing a pre-equalization function at least in part based on the obtained CSI estimate; (3) determining a modulated signal of the source information bits according to the supported states of the ADC of the first radio node (e.g., source coded information bits are mapped into a sequence of modulated time-domain complex valued sequence); (4) performing pre-equalization of the estimated channel on the determined modulated complex time-domain sequence of the source information bits.

FIG. 5 illustrates a signaling diagram 500 in accordance with aspects of the present disclosure The signaling diagram 500, for instance, illustrates steps including CSI estimation at the second radio node 404 and pre-equalization of a modulated signal prior to transmission. According to some implementations, the second radio node 404 can be self-configured and/or configured/indicated by the configuration entity 406 for performing one or more of the steps (e.g., in a same or an alternate order, with potential repetition or deletion of one or more of the steps) of the signaling diagram 500, such as described in the following.

Step 1: Capability information exchange. Step 1 can include indication/description of the LR reception and/or transmission behavior of the first radio node 402, where the description of the LR reception behavior of the first radio node 402 may include at least one or more of: (1) all or a subset of the supported discrete ADC steps; (2) number (equal or smaller than the number) of the ADC bits; (3) possible scaling of the supported ADC value steps/value range; (4) information/description of an analog function (e.g., of an Automatic Gain Control (AGC)) which may be utilized by the first radio node 402 to adjust the received analog signal values to the quantization steps of the ADC (prior to the ADC block), e.g., an analog function on the analog baseband complex values including possible/range for amplification/attenuation and/or delay/phase rotation with the received analog baseband values at the Rx radio chain as input and analog baseband complex values as output (e.g., for which the output of the analog function feed to the input of the ADC); (5) an index indicating an ADC type/description and/or the supported analog/gain function from a codebook/table where the codebook/table includes possible supported ADC description (e.g., set of supported discrete steps) and/or the supported analog functions.

In some implementations, the indication of the LR Rx and/or Tx behavior of a radio node includes indication of an adjustable/controllable/programmable accuracy/resolution, e.g., the ADC and/or DAC resolution or number of bits may be adjusted among at least two values. As such, the resolution adjustment of the node with the LR behavior may be determined autonomously or via indication of the configuration entity. In some such implementations, the adjustable LR resolution/behavior may be indicated via multiple indications of the LR behavior each including a supported/feasible LR behavior.

In some implementations, indication of an LR Rx behavior and an LR Tx behavior can be performed jointly, where one or more parameters/parameter values jointly describe an LR Rx and Tx behavior/conditions. In some examples, the first radio node 402 may indicate a joint Tx LR and Rx LR condition via the same indication, e.g., indication of the Rx LR behavior also indicates a Tx LR behavior or vice versa; the number of ADC and DAC bits are defined with the same indication (e.g., including a shared parameter indication for quantization resolution, number of quantization steps/bits); and/or an index from a codebook/table, where the table (e.g., Table 4, below) includes joint possible descriptions of the Rx and Tx LR behavior of the first radio node 402.

TABLE 4
An example Table/codebook including descriptions
of LR Rx and Tx behavior of the first node.

| Index | Rx-LR description | Tx-LR description |
|---|---|---|
| 0 | 1 bit ADC | 1 bit ADC |
| 1 | 1 bit ADC | 2 bits DAC |
| 2 | 2 bits ADC | 2 bits DAC |
| . . . | . . . | . . . |

Step 2: Configuration of parameters of the first radio node 402 and the second radio node 404. For instance, responsive to receiving an indication of LR Tx/Rx behavior of the first radio node 402, the configuration entity 406 can configure the first radio node 402 and/or the second radio node 404. Step 2 can include configuration, indication, self-configuration and/or determination of the configuration parameters of the first and second radio node, including at least one or more of RS transmission and L1 measurement, configuration of an RS (e.g., discrete time-domain RS (DT-RS) transmission, when first radio node 402 includes an LR transmission). In some examples, the configuration of the DT-RS transmission from the first radio node 402 can be based on/subsequent to the first radio node 402 indication of the LR ADC condition. Interacting with an LR radio, the ADC distortions on channel estimation can be more difficult to eliminate than the DAC distortion. Hence, the CSI estimation can be performed at the link initiated from the LR radio rather than terminated.

Further, Step 2 can include transmission configuration of the second radio node 402 including one or more of channel coding and data modulation and channel inversion/pre-equalization scheme, where the transmission configuration parameters (or a subset thereof) may be determined (e.g., by the configuration entity 406) according to and/or include indication/description of the LR reception behavior of the first radio node 402. In some examples, the transmission configuration can include indication and/or description/configuration parameters of the channel inversion/pre-equalization at the second radio node 404. In one example, the data/information bits of the second radio node 404 can be modulated into a time-domain sequence of complex values according to the supported set of the complex ADC steps (as the transmission time-domain complex sequence s(t)), and where the channel pre-equalization minimizes the distance between the expected received complex sample values prior to the ADC of the first radio node and the supported set by the ADC of the first radio node. In some examples, the constellation points of the data modulation scheme can be chosen according to the full or subset of the supported complex valued ADC steps of the first radio node. The constellation points of the data modulation scheme may be a deviation from the quadrature amplitude modulation (QAM) constellation points due to the distance and inclusion of a zero-valued point.

Further, Step 2 can include equalization configuration where the second radio node 404 can be configured with the equalization configuration, including indication of the Tx channel inversion/pre-equalization at the second radio node 404. In some examples, equalization configuration can be performed upon reception (e.g., by the first radio node 402) of the equalization configuration containing indication of the channel inversion at the second radio node 404.

Step 3: RS transmission. Step 3 can include transmission of RS by the first radio node 402 for CSI estimation/measurement, according to the received configuration for RS transmission, and reception of the RS and CSI measurements according to the received configuration. Step 4: CSI estimation, pre-equalization function determination. Step 4 can include determination of the pre-equalization by the first radio node 402, including in some examples a determination of the channel inversion/pre-equalization which can be performed according to an indicated measure of error. For instance, if mean square error (MSE) of the received time-domain samples is below an indicated absolute or relative (e.g., to the distance of ADC steps) threshold, based on the indicated maximum pre-equalization delay, CSI estimation quality, etc.], the pre-equalization function can be computed. Step 5: Transmission (including modulation, pre-equalization). Step 5 can include transmission of the modulated and pre-equalized signal according to the received modulation and pre-equalization configuration. Step 6: Demodulation. Step 6 can include demodulation of the received signal at the first radio node 402 based on the received pre-equalized signal.

In some implementations (e.g., an LR Rx UE with time division duplex (TDD) connection to a NE), the first radio node 402 can be a UE with an LR condition for both reception and transmission (e.g., the UE is equipped with 1-bit real/imaginary Rx ADCs and 1-bit real/imaginary Tx DACs), where the UL transmission and DL reception of the UE can be separated via TDD. Upon indication of the LR reception behavior of the UE (e.g., as a capability information element) to the configuration entity 406 (e.g., a NE, a RAN node, and/or the serving gNB of the UE), the configuration entity 406 can determine a channel estimation/measurement to be done via a DT-RS transmission of the UE and measurement of the serving NE, e.g., NE/gNB/RAN node. For instance, the UE Rx measurement behavior can be determined to be unreliable due to the added ADC distortion, and the DT-RS transmission of the UE and measurement by the NE may not experience the LR quantization distortion of the UE.

In implementations and based on the measurements of the UL DT-RS transmission by the UE (including measurements of multiple/different Tx/Rx pairs of antenna ports/beams at the UE and the NE), a Tx/Rx beam can be selected by the NE. In some such implementations, the UE Tx/Rx beams can be generated via an analog phase shifter antenna array, such that unlike the LR Tx and/or Rx signal reception and transmission, the spatial beam forming can be done with a known and sufficient accuracy. As such, in some examples, the spatial beams and/or spatial beamforming capability of the first radio node 402 associated with an LR condition for reception and/or condition may not be impacted/associated with the LR Tx/Rx condition, e.g., determined as an RF chain with an analog, potentially high resolution phase shifter or time-delay array, Tx and/or Rx beams, with a corresponding LR ADC and/or DAC.

In some implementations, the first radio node 402 may not be expected to perform CSI measurements for beam determination. Thus, the first radio node 402, upon indication of the Rx LR behavior, can be indicated/configured/pre-configured to assume one TDD operations for transmission and reception and the Tx beam of the selected/indicated Tx beam (e.g., during a DT-RS transmission by the first radio node 402 and measurement by the second radio node 404) for the corresponding reception of the data/control information from the second radio node. As such, based on transmission of UL DT-RS by the UE (e.g., via plurality of Tx antenna ports/beams) and reception/measurement by the NE (e.g., via plurality of Rx antenna ports/beams), at least one Tx beam/antenna port of the UE and at least a corresponding Rx beam of the NE can be chosen/selected/indicated for use at the UE and NE for the UL transmission and reception such that the selected UL beam of the UE can be utilized both for the configured UL transmission and for the DL reception of the data/control information. In implementations this can represent HR analog beam selection for an LR Rx/Tx chain.

In implementations, information including any of the configurations/indications/reporting (e.g., configuration/indication of transmission and/or reception/measurement and/or reporting of the first and/or second radio node) or a subset thereof can be exchanged between the radio configuration entity 406, the first radio node 402, and/or the second radio node 404 via the UL, DL, or SL physical data and/or control channels defined within the communication network, e.g., NR physical broadcast channel (PBCH), PDSCH, physical downlink control channel (PDCCH), PUSCH, PUCCH, physical sidelink broadcast channel (PSBCH), physical sidelink control channel (PSCCH), physical sidelink shared channel (PSSCH), and/or via a higher layer (medium access control (MAC)-control element (CE) or radio resource control (RRC)) signaling.

In implementations a new Rs type can be defined, herein described as an Rx-RS, where the Rx-RS defines the reference signal values as expected to be measurable/observable at the Rx of the first radio node 402. For instance, current DMRS can be defined by “what radio shall assume as being transmitted”, and Rx-DMRS can be defined as what is intended to be observed/received by a radio node. In some implementations, the Rx-RS can be defined at the input stage of the Rx ADCs of the first radio node, e.g., the expected signal/values to be received/observable by the first radio node 402 at the input of the Rx ADCs. In some implementations, the Rx-RS can be defined at the output stage of the Rx ADCs of the first radio node 402, e.g., the expected quantized complex (combined real and imaginary) signal/values to be received/measured by the first radio node 402. As such, the first radio node 402, upon reception of an Rx-RS configuration, can assume the defined Rx-RS as values received at the input or output of the Rx ADCs. In some implementations, a transmission by the second radio node 404 or reception by the first radio node 402 of an Rx-RS can be multiplexed with a second transmission of the second radio node 404 or second reception of the first radio node 402 in time domain, according to a time-domain multiplexing pattern. In some implementations, upon configuration of an Rx-RS for the first radio node 402 or any RS for the first radio node 402 subsequent to the indication of the LR behavior of the first radio node, the first radio node 402 can assume a time-domain multiplexing of the said Rx-RS/RS with a second reception, such that the second reception and the said Rs-RS/RS do not share a same time resource.

In some implementations, transmission of an antenna port/beam can be associated with a channel inversion/pre-equalization step. As such, the transmitted data/control information-modulated signal and/or transmission of an RS from the beam/antenna port associated with the channel inversion/pre-equalization step can be assumed by the received as the (expected) received signal containing the RS and/or the data/control information-modulated signal. In some such implementations, definition/configuration of an Rx-RS can include indication/definition/configuration parameters of a known RS (defined as the transmitted RS signal, e.g., DL CSI-RS/positioning reference signal (PRS)) together with indication of a channel inversion/pre-equalization step subsequent to the defined RS values. In some implementations, the definition/configuration of an Rx-RS for the first radio node can indicate (implicitly) a channel inversion/pre-equalization step within the transmission of the second radio node.

In some implementations, the Rx-RS can be defined in the time-domain, e.g., as a time-domain sequence of complex values at the input or output stage of the Rx ADCs. In some implementations, the sequence of complex values can be within the supported discrete steps of the Rx ADCs. In some implementations, the configuration parameters defining an Rx-RS including one or more of a sequence of complex values representing the expected reference signal values at the input or output stage of the Rx ADC, a beam/antenna port number/ID associated with the reception of the Rx-RS, and/or timing information of the Rx-RS. The timing information of the Rx-RS can include a time window including a start time and an end time for presence of the Rx-RS and/or sampling time according to which the defined sequence values can be mapped to the ADC input/output values.

In some implementations, when the defined/configured (e.g., by the configuration entity 406) Rx-RS values are/are not according to the discrete steps supported by the ADCs of the first radio node 402 (e.g., Rx-RS values include values which may not be quantized/observed/received by the first radio node 402 without quantization distortion below an indicated/chosen threshold), the first radio node 402 can perform various actions including: (1) indicating the suitability/unsuitability of the configured Rx-RS to the configuration entity in view of the adjusting of the values to the Rx ADCs; (2) adjusting the configuration parameters of the Rx-RS and reports back the adjusted modified parameters; (3) assuming the updated/adjusted Rx-RS parameters subsequent to the reporting of the adjusted/modified parameters (in some examples, the adjusted/updated Rx-RS parameters assumed to be the Rx-RS parameters by the first radio node after a known time-delay).

In some implementations, the Rx-RS can be defined in association with a second transmission and/or reception, e.g., a QCL type between an Rx-RS and reception of a data/control information. In some implementations, the association between the reception of an Rx-RS and the second reception of a second RS or of a second data/control information can indicate one of more of: (1) the same beam/antenna port used for the reception and/or transmission of the second transmission and/or reception and the Rx-RS; (2) the same state/type of channel inversion/pre-equalization can be present for the Rx-RS and the second transmission/reception (e.g., the channel inversion step or a same Tx pre-equalization process can be present between both Rx-RS and the second transmission); (3) the second transmission/reception can be associated with all or a subset of the discrete values associated with the Rx-RS reception.

Implementations provide for LR node behavior in reception of Rx-RS. For instance, upon reception of the configuration parameters of an Rx-RS, the first radio node 402 can be configured to perform one or more of the following actions: (1) measuring the received Rx-RS according to a received configuration for the Rx-RS measurements; (2) reporting a measured/configured quantity based on reception of the configured Rx-RS. In some examples, the measurement quantity may include one or more of a measure of error for the reception of the configured Rx-Rs values (e.g., probability/rate of receiving the same discrete point as configured in the Rx-RS), Mean/average Squared or averaged Error of the received Rx-RS values, a determined adjustment of the received values including a function operating on the received sequence of time domain complex values (e.g., including one or more of phase rotation, amplification/attenuation, time-domain convolution or frequency-domain selective attenuation) to be applied on the transmitted signal of the Rx-RS such that the received values may match the expected Rx-RS sequence; (3) adjusting a demodulation processing/strategy for reception of a modulated signal received with association/relation with the received Rx-RS (e.g., upon detection of a rotation or a measurable mismatch or gain/level mismatch of the received signal, the first radio node 402 performs compensation of the received modulated signal based on the obtained measurement/adjustments); (4) transmitting an RS (e.g., DT-RS) as configured upon satisfaction of an indicated or self-determined condition. For instance, upon the received/observed values of the configured Rx-RS deviates from the configured expected values, the first radio node 402 can determine the need for CSI adjustment and/or re-transmission of an RS (e.g. a previously configured DT-RS), and thereby can trigger/initiate transmission of the RS.

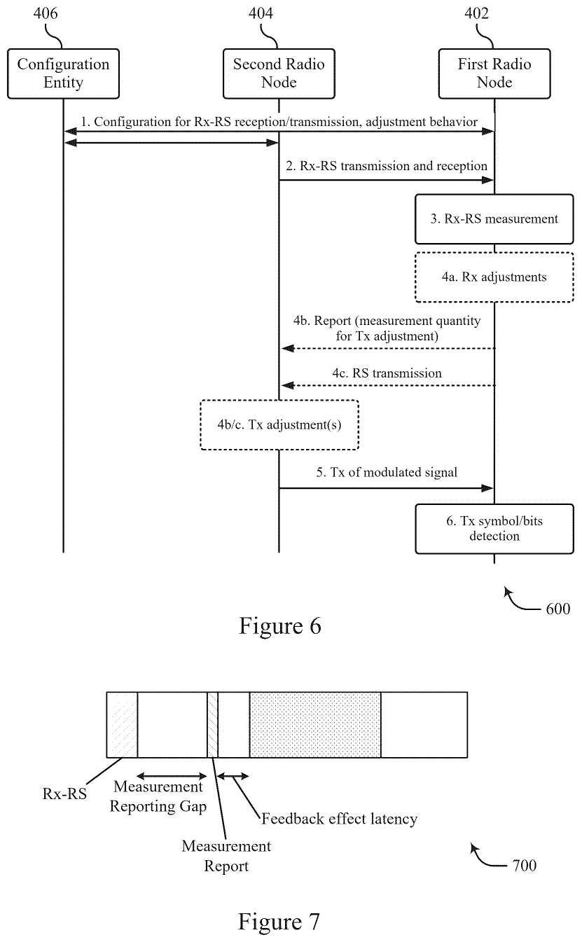

FIG. 6 illustrates a signaling diagram 600 in accordance with aspects of the present disclosure. The signaling diagram 600, for instance, illustrates steps for configuration and reporting of an Rx-RS, including Tx/Rx adjustments based on reception and/or reporting of the Rx-RS. In some implementations, including reception of a configured Rx-RS by the first radio node 402, the first and second radio nodes can be self-configured and/or configured/indicated by the configuration entity 406 for performing one or more of the steps described in the signaling diagram 600. The steps in the signaling diagram 600 may be performed in a same or an alternate order, with potential repetition or deletion of one or more of the steps.

The signaling diagram 600 includes: Step 1: Communication of configuration information. For instance, Step 1 includes configuration for Rx-RS reception/transmission, adjustment behavior, such as configuration of the transmission/reception of the Rx-RS including parameters defining the Rx-RS. Step 2: Transmission of the Rx-RS by the second radio node 404. Different attributes of the Rx-RS are described throughout this disclosure. Step 3: Reception and measurement of the transmitted Rx-RS (e.g., according to the received configuration by the first radio node 402) which can include ADC resolution adjustment during the Rx-Rs reception and measurement/adjustment phase. In some implementations, where the first radio node 402 can be indicated/associated with plurality of the Rx LR behaviors (e.g., the supported ADC resolution of both 1 bit and 3 bits), the first radio node 402 can be configured or assumed to operate with the second/indicated LR behavior (e.g., higher reception resolution) for the reception and/or measurements of the Rx-RS. In some such examples, upon reception and measurement/adjustment at the first radio node 402 of the Rx-RS, the first radio node 402 can be assumed/configured to operate with the first LR behavior (e.g., the 1 bit ADC reception) for reception of the second transmission (e.g., of the modulated signal with data/control information) other than the configured Rx-RS, where the operation with the higher resolution convertors can be restricted to the RS reception phase.

Steps 4a, 4b, 4c, 4b/c: The first radio node 402 can perform one or more of Step 4a adjusting of the reception behavior based on reception of the Rx-RS (e.g., as described above); Step 4b reporting a configured/measured quantity based on reception of the Rx-RS (e.g., as described above); Step 4c transmission of an RS (e.g., a configured DT-RS) for adjusted CSI estimation/measurement and channel inversion/pre-equalization adjustment of the second radio node 404 (e.g., as described above); and/or a combination of Steps 4b/4c for Tx adjustment(s). Step 5: Tx of modulated signal. Step 5, for instance, can include transmission of a second transmission containing a data/control information modulated signal, associated with the transmission of the Rx-RS (with QCL relation/association of one or more transmission/reception parameters such as described above). Step 6: Tx symbol/bits detection. Step 6, for instance, can include reception and demodulation/detecting of the transmitted signal of the second transmission. In some implementations, the detection of the transmitted symbols can be performed by the ADCs, where the outcome of the Rx ADCs of the first radio node 402 can be considered as the detected constellation points.

In some implementations, the behavior of the first radio node 402 for reception and/or processing/measurement/reporting of the Rx-RS can include one or more of a time delay between reception of the Rx-RS and the time where a measurement quantity based on reception of the Rx-RS can be reported, and/or a time-delay between the indication of a measurement report and the time where the first radio node 402 may assume reception of a second transmission with the impact of the indicated adjustment.

FIG. 7 illustrates a time delay diagram 700 in accordance with aspects of the present disclosure. The time delay diagram 700, for instance, illustrates example time delays assumed/configured for the first radio node 402 between reception of an Rx-RS and transmission of a measurement report feedback and/or reception of an adjusted second transmission including modulated data/control information.

In some implementations, the Rx-RS can be a DMRS associated with a second transmission by the second radio node 404 and received by the first radio node 402. In some implementations, the time-delay (e.g., minimum/maximum/assumed) between reception of the configured Rx-RS and transmission of the measurement report by the first radio node 402, and/or the time-delay (e.g., (minimum/maximum/assumed) between the transmission of the measurement report by the first radio node) 402 and reception of the second transmission (e.g., containing a second RS or a second signal containing modulated data/control information) can be such that the second transmission can be adjusted to the transmitted measurement report/feedback of the first radio node 402. The time delay (e.g., “measurement reporting gap”), for instance, can be configured/pre-configured/indicated by the configuration entity 406 to the first radio node 402 such as depicted in the time delay diagram 700.

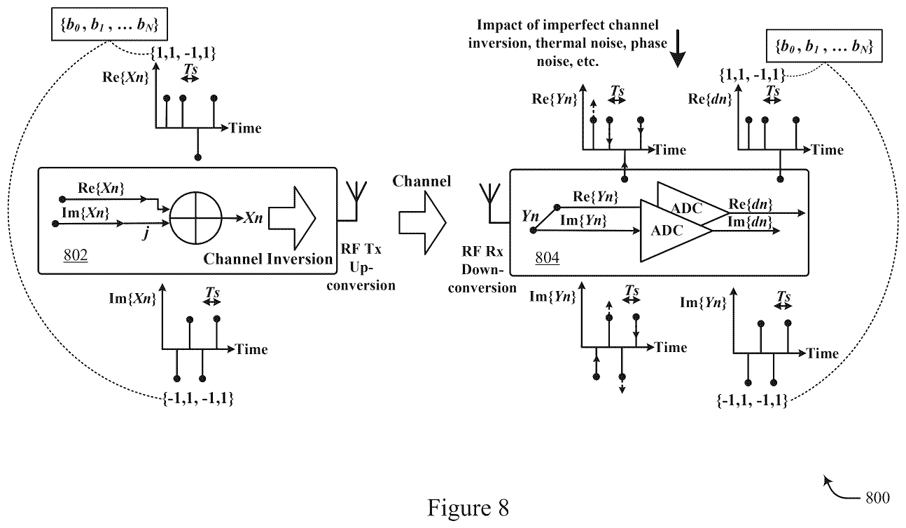

FIG. 8 illustrates an example scenario 800 in accordance with aspects of the present disclosure. The scenario 800, for example, includes a transmitter node 802 (e.g., the second radio node 404) and a receiver node 804, e.g., the first radio node 402. The scenario 800 depicts an example of data modulation and reception according to the Rx ADC, including modulation of the input bit sequence into a time-domain modulated signal with values according to the Rx ADCs, a channel inversion step at the transmitter node 802, and detection of the (uncoded) Tx bit at the receiver node 804.

Implementations enable ADC discrete-aware modulation and pre-equalization. For instance, the second radio node 404 can be configured/self-configured with transmission of modulated signal of the data/control information, where the modulation includes mapping of the transmission bits (e.g., of the data/control information) into a time-domain sequence of values for transmission of the transmission signal of the second radio node 404. Further, the mapping of the information bits into sequence of complex values can be determined by the configuration entity 406 and/or the second radio node 404 according to the indicated/reported LR behavior/capability of the first radio node 402. An example process of some implementations is depicted in the scenario 800 including modulation at the transmitter node 802 (e.g., second radio node 804) of the input bit sequence into a time-domain modulated signal including values according to the Rx ADCs, a channel inversion step at the transmitter node 802, and detection of the (uncoded) Tx bit at the receiver node 804 (e.g., first radio node 402) based on ADC conversion.

In some implementations, the complex values of the time-domain sequence can be selected from a set of potential complex values, e.g., a set of constellation points corresponding to the discrete complex values supported by the ADCs of the first radio node 402. In some such examples, each complex value of the time-domain sequence and/or a group of (e.g., subsequent) complex values of the sequence can correspond/map to one or multiple of the transmission information bits. In some such examples, the set of constellation points can be determined according to the LR behavior of the first radio node 402 (e.g., the supported ADC steps of the first radio node). In some examples, the mapping of the Tx information bits into the sequence of complex values can be described as

$$\{ {b}_{0} , {b}_{1} , … , {b}_{M - 1} \} \to \{ {x}_{0} , {x}_{1} , … , {x}_{N - 1} ∈ {𝒟}_{ADC} \}$$

where the sequence b₀ . . . b_{M-1} represents the input bit sequence for transmission from the second radio node 404 and x₀ . . . x_{N-1} is the sequence of modulated complex values. In the above mapping, the integer values M, N respectively represent the number of bits and the number of the sample complex values mapped within each block of the modulation. For instance, M-bits are mapped into the N samples of complex values as time-domain modulated signal from the second radio node. In the scenario 800, Re{Xn} represent real representations of transmission bits Xn and Im{Xn} represent imaginary representations of transmission bits Xn. Further, Re {Yn} represent real representations of reception bits Yn, Im{Yn} represent imaginary representations of reception bits Yn, Re{dn} represent real representations of converted reception bits and Im{dn} represent imaginary representations of converted reception bits. Further, Ts represents sampling time at the transmitter node 802 and the receiver node 804, respectively.

In some implementations, the modulation and/or mapping of the input bit sequences into the sequence of discrete complex values can be described via an index from a codebook, where the codebook indicates possible one or more of channel coding or modulation/mapping parameters. In some implementations, the codebook/index further indicates implicitly or explicitly (e.g., implicit to the codebook type from which the mapping/modulation-defining index can be indicated, or explicitly as defined within the codebook) of a channel inversion step as subsequent to the modulation/mapping step. Accordingly, the outcome of the modulation/mapping as the time-domain sequence of discrete complex values can be assumed/expected to be received at the ADC of the first radio node 402 as transmitted/generated by the modulation/mapping step.

In some implementations, the following conditions/parameters or a subset thereof are specified/defined as part of a modulation/mapping parameters defining codebook/table:
The number/size of the constellation points (e.g., a 4-QAM, 16 QAM, constellation points corresponding to the ADC steps, number of discrete ADC steps or bits)
M, i.e., number of transmission bits modulated/mapped within each mapping block
N, i.e., number of time-domain complex samples as outcome of each mapping block
Mapping rate (e.g., N/M or M/N)

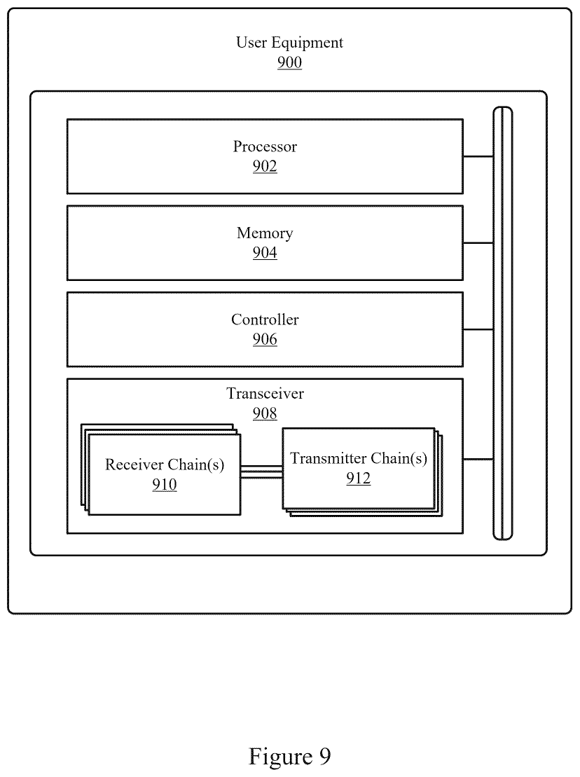

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces. In implementations, the UE 900 may represent a first radio node and/or a second radio node, such as described throughout this disclosure including the accompanying claims.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904).

For example, the processor 902 may support wireless communication at the UE 900 in accordance with examples as disclosed herein. The UE 900 may be configured to or operable to support a means for transmitting first configuration information including one or more low-resolution receive behaviors of the UE; receiving second configuration information for reception of a modulated signal, wherein the second configuration information is based at least in part on the first configuration information; and receiving, based at least in part on the second configuration information, the modulated signal including one or more of data or control information.

Additionally, the UE 900 may be configured to support any one or combination of where the one or more low-resolution receive behaviors of the UE are associated with a low resolution ADC of the UE; further including: receiving third configuration information for reception of a reference signal; and receiving one or more first reference signals based at least in part on the third configuration information; the one or more first reference signals include one or more reference signal values indicated to be measurable at a receiver of the UE; the one or more first reference signals are defined at one or more of an input stage of an ADC of the UE or an output stage of the ADC of the UE; the third configuration information includes an indication of one or more of channel inversion or pre-equalization, and wherein the method further includes determining whether the one or more of the channel inversion or the pre-equalization is executable within an indicated error measure; based at least in part on receiving the one or more first reference signals, the method further includes one or more of: performing measurement of the one or more first reference signals; reporting the performed measurement; or transmitting one or more second reference signals with one or more transmission parameters quasi-co-located with the one or more first reference signals.

Additionally, the UE 900 may be configured to support any one or combination of one or more of: receiving the third configuration information based at least in part on transmission of the first configuration information; or receiving the third configuration information subsequent to transmission of the first configuration information; the third configuration information includes an indication of a predefined reference signal and an indication of one or more of a channel inversion or pre-equalization applied to the predefined reference signal; the third configuration information includes a definition of the one or more first reference signals in a time domain including an indication of a time-domain sequence of complex values at one or more of an input stage or an output stage of an ADC of the UE; further including one or more of: transmitting an indication of a compatibility of the one or more first reference signals; adjusting one or more parameters of the one or more first reference signals and report one or more adjusted parameters of the one or more first reference signals; or assuming the one or more adjusted parameters of the one or more first reference signals in association with reporting the one or more adjusted parameters of the one or more first reference signals; further including adjusting demodulation of the modulated signal received in association with the one or more first reference signals; the first configuration information includes one or more of: a baseband analog function computation capability indication associated with the UE; a programmable ADC resolution; or an association of the one or more low-resolution receive behaviors of the UE with one or more low-resolution transmit behaviors of the UE.

As a further example, the processor 902 may support wireless communication at the UE 900 in accordance with examples as disclosed herein. The UE 900 may be configured to or operable to support a means for receiving first configuration information including one or more low-resolution receive behaviors of a first radio node; transmitting second configuration information for reception of a modulated signal, wherein the second configuration information is based at least in part on the first configuration information; and transmitting, based at least in part on the second configuration information, the modulated signal including one or more of data or control information.

Additionally, the UE 900 may be configured to support any one or combination of modulating the modulated signal into a time-domain sequence of complex values based at least in part on one or more ADC steps supported by the first radio node; further including: transmitting third configuration information for reception of reference signal; and transmitting one or more first reference signals based at least in part on the third configuration information; the third configuration information includes an indication of one or more of channel inversion or pre-equalization applied at the UE; the one or more low-resolution receive behaviors of the first radio node are associated with a low resolution ADC of the first radio node.

Additionally, or alternatively, the UE 900 may support at least one memory (e.g., the memory 904) and at least one processor (e.g., the processor 902) coupled with the at least one memory and configured to cause the UE transmit first configuration information including one or more low-resolution receive behaviors of the UE; receive second configuration information for reception of a modulated signal, wherein the second configuration information is based at least in part on the first configuration information; and receive, based at least in part on the second configuration information, the modulated signal including one or more of data or control information.

Additionally, the UE 900 may be configured to support any one or combination of where the one or more low-resolution receive behaviors of the UE are associated with a low resolution ADC of the UE; the at least one processor is configured to cause the UE to: receive third configuration information for reception of a reference signal; and receive one or more first reference signals based at least in part on the third configuration information; the one or more first reference signals include one or more reference signal values indicated to be measurable at a receiver of the UE; the one or more first reference signals are defined at one or more of an input stage of an ADC of the UE or an output stage of the ADC of the UE; the third configuration information includes an indication of one or more of channel inversion or pre-equalization, and wherein the at least one processor is configured to cause the UE to determine whether the one or more of the channel inversion or the pre-equalization is executable within an indicated error measure; based at least in part on receiving the one or more first reference signals, the at least one processor is configured to cause the UE to one or more of: perform measurement of the one or more first reference signals; report the performed measurement; or transmit one or more second reference signals with one or more transmission parameters quasi-co-located with the one or more first reference signals.

Additionally, the UE 900 may be configured to support any one or combination of where the at least one processor is configured to cause the UE to one or more of: receive the third configuration information based at least in part on transmission of the first configuration information; or receive the third configuration information subsequent to transmission of the first configuration information; the third configuration information includes an indication of a predefined reference signal and an indication of one or more of a channel inversion or pre-equalization applied to the predefined reference signal; the third configuration information includes a definition of the one or more first reference signals in a time domain including an indication of a time-domain sequence of complex values at one or more of an input stage or an output stage of an ADC of the UE; the at least one processor is configured to cause the UE to one or more of: transmit an indication of a compatibility of the one or more first reference signals; adjust one or more parameters of the one or more first reference signals and report one or more adjusted parameters of the one or more first reference signals; or assume the one or more adjusted parameters of the one or more first reference signals in association with reporting the one or more adjusted parameters of the one or more first reference signals; the at least one processor is configured to cause the UE to adjust demodulation of the modulated signal received in association with the one or more first reference signals; the first configuration information includes one or more of: a baseband analog function computation capability indication associated with the UE; a programmable ADC resolution; or an association of the one or more low-resolution receive behaviors of the UE with one or more low-resolution transmit behaviors of the UE.

Additionally, or alternatively, the UE 900 may support at least one memory (e.g., the memory 904) and at least one processor (e.g., the processor 902) coupled with the at least one memory and configured to cause the UE to receive first configuration information including one or more low-resolution receive behaviors of a first radio node; transmit second configuration information for reception of a modulated signal, wherein the second configuration information is based at least in part on the first configuration information; and transmit, based at least in part on the second configuration information, the modulated signal including one or more of data or control information.

Additionally, the UE 900 may be configured to support any one or combination of where the at least one processor is configured to cause the UE to modulate the modulated signal into a time-domain sequence of complex values based at least in part on one or more ADC steps supported by the first radio node; the at least one processor is configured to cause the UE to: transmit third configuration information for reception of reference signal; and transmit one or more first reference signals based at least in part on the third configuration information; the third configuration information includes an indication of one or more of channel inversion or pre-equalization applied at the UE; the one or more low-resolution receive behaviors of the UE are associated with a low resolution ADC of the first radio node.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or QAM. The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

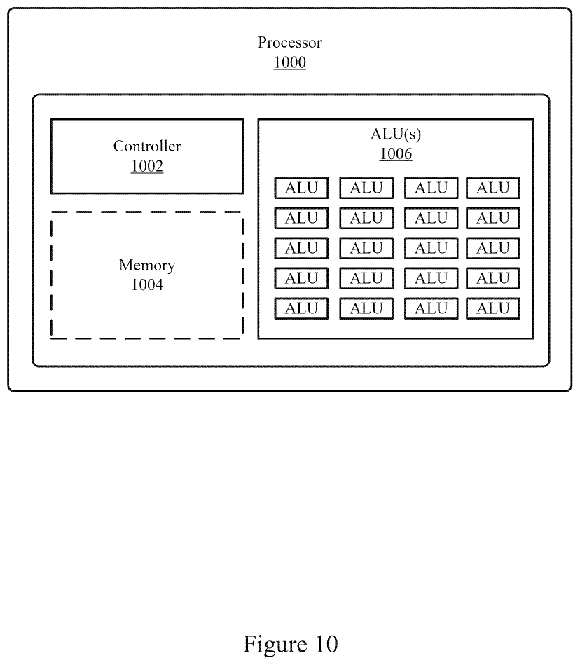

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses). In implementations, the processor 1000 may represent a first radio node and/or a second radio node, such as described throughout this disclosure including the accompanying claims.

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to transmit first configuration information including one or more low-resolution receive behaviors of a first radio node; receive second configuration information for reception of a modulated signal, wherein the second configuration information is based at least in part on the first configuration information; and receive, based at least in part on the second configuration information, the modulated signal including one or more of data or control information.

Additionally, the processor 1000 may be configured to or operable to support any one or combination of where the one or more low-resolution receive behaviors of the first radio node are associated with a low resolution ADC of the first radio node; the at least one controller is configured to cause the processor to: receive third configuration information for reception of a reference signal; and receive one or more first reference signals based at least in part on the third configuration information; the one or more first reference signals include one or more reference signal values indicated to be measurable at a receiver of the first radio node; the one or more first reference signals are defined at one or more of an input stage of an ADC of the first radio node or an output stage of the ADC of the first radio node; the third configuration information includes an indication of one or more of channel inversion or pre-equalization, and wherein the at least one controller is configured to cause the processor to determine whether the one or more of the channel inversion or the pre-equalization is executable within an indicated error measure; based at least in part on receiving the one or more first reference signals, the at least one controller is configured to cause the processor to one or more of: perform measurement of the one or more first reference signals; report the performed measurement; or transmit one or more second reference signals with one or more transmission parameters quasi-co-located with the one or more first reference signals; the at least one controller is configured to cause the processor to one or more of: receive the third configuration information based at least in part on transmission of the first configuration information; or receive the third configuration information subsequent to transmission of the first configuration information.

Additionally, the processor 1000 may be configured to or operable to support any one or combination of where the third configuration information includes an indication of a predefined reference signal and an indication of one or more of a channel inversion or pre-equalization applied to the predefined reference signal; the third configuration information includes a definition of the one or more first reference signals in a time domain including an indication of a time-domain sequence of complex values at one or more of an input stage or an output stage of an ADC of the first radio node; the at least one controller is configured to cause the processor to one or more of: transmit an indication of a compatibility of the one or more first reference signals; adjust one or more parameters of the one or more first reference signals and report one or more adjusted parameters of the one or more first reference signals; or assume the one or more adjusted parameters of the one or more first reference signals in association with reporting the one or more adjusted parameters of the one or more first reference signals; the at least one controller is configured to cause the processor to adjust demodulation of the modulated signal received in association with the one or more first reference signals; the first configuration information includes one or more of: a baseband analog function computation capability indication associated with the first radio node; a programmable ADC resolution; or an association of the one or more low-resolution receive behaviors of the first radio node with one or more low-resolution transmit behaviors of the first radio node.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to receive first configuration information including one or more low-resolution receive behaviors of a first radio node; transmit second configuration information for reception of a modulated signal, wherein the second configuration information is based at least in part on the first configuration information; and transmit, based at least in part on the second configuration information, the modulated signal including one or more of data or control information.

Additionally, the processor 1000 may be configured to or operable to support any one or combination of where the at least one controller is configured to cause the processor to modulate the modulated signal into a time-domain sequence of complex values based at least in part on one or more ADC steps supported by the first radio node; the at least one controller is configured to cause the processor to: transmit third configuration information for reception of reference signal; and transmit one or more first reference signals based at least in part on the third configuration information; the third configuration information includes an indication of one or more of channel inversion or pre-equalization applied at a second radio node; the one or more low-resolution receive behaviors of the first radio node are associated with a low resolution ADC of the first radio node.

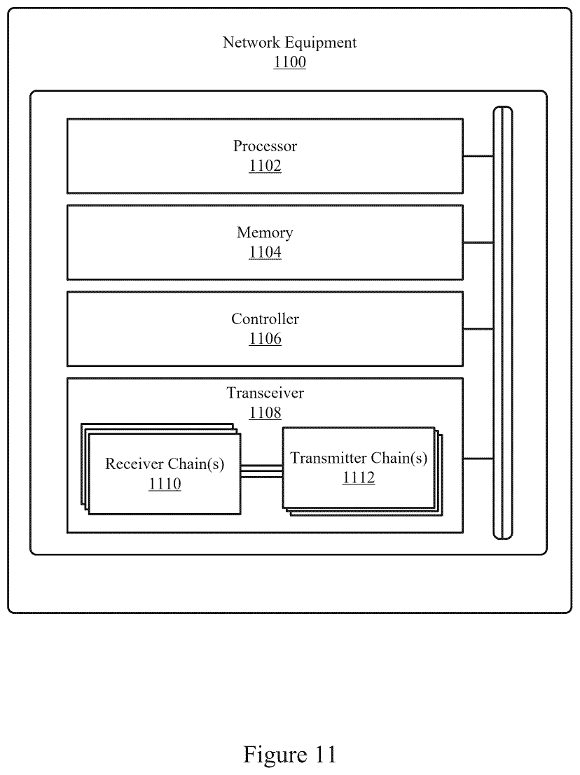

FIG. 11 illustrates an example of a NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces. In implementations, the NE 1100 may represent a first radio node and/or a second radio node, such as described throughout this disclosure including the accompanying claims.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104).

For example, the processor 1102 may support wireless communication at the NE 1100 in accordance with examples as disclosed herein. The NE 1100 may be configured to or operable to support a means for transmitting first configuration information including one or more low-resolution receive behaviors of the NE; receiving second configuration information for reception of a modulated signal, wherein the second configuration information is based at least in part on the first configuration information; and receiving, based at least in part on the second configuration information, the modulated signal including one or more of data or control information.

Additionally, the NE 1100 may be configured to or operable to support any one or combination of where the one or more low-resolution receive behaviors of the NE are associated with a low resolution ADC of the NE; further including: receiving third configuration information for reception of a reference signal; and receiving one or more first reference signals based at least in part on the third configuration information; the one or more first reference signals include one or more reference signal values indicated to be measurable at a receiver of the NE; the one or more first reference signals are defined at one or more of an input stage of an ADC of the NE or an output stage of the ADC of the NE; wherein the third configuration information includes an indication of one or more of channel inversion or pre-equalization, and wherein the method further includes determining whether the one or more of the channel inversion or the pre-equalization is executable within an indicated error measure; based at least in part on receiving the one or more first reference signals, the method further includes one or more of: performing measurement of the one or more first reference signals; reporting the performed measurement; or transmitting one or more second reference signals with one or more transmission parameters quasi-co-located with the one or more first reference signals.

Additionally, the NE 1100 may be configured to or operable to support any one or combination of one or more of: receiving the third configuration information based at least in part on transmission of the first configuration information; or receiving the third configuration information subsequent to transmission of the first configuration information; the third configuration information includes an indication of a predefined reference signal and an indication of one or more of a channel inversion or pre-equalization applied to the predefined reference signal; the third configuration information includes a definition of the one or more first reference signals in a time domain including an indication of a time-domain sequence of complex values at one or more of an input stage or an output stage of an ADC of the NE; further including one or more of: transmitting an indication of a compatibility of the one or more first reference signals; adjusting one or more parameters of the one or more first reference signals and report one or more adjusted parameters of the one or more first reference signals; or assuming the one or more adjusted parameters of the one or more first reference signals in association with reporting the one or more adjusted parameters of the one or more first reference signals; further including adjusting demodulation of the modulated signal received in association with the one or more first reference signals; the first configuration information includes one or more of: a baseband analog function computation capability indication associated with the NE; a programmable ADC resolution; or an association of the one or more low-resolution receive behaviors of the NE with one or more low-resolution transmit behaviors of the NE.

For example, the processor 1102 may support wireless communication at the NE 1100 in accordance with examples as disclosed herein. The NE 1100 may be configured to or operable to support a means for receiving first configuration information including one or more low-resolution receive behaviors of a first radio node; transmitting second configuration information for reception of a modulated signal, wherein the second configuration information is based at least in part on the first configuration information; and transmitting, based at least in part on the second configuration information, the modulated signal including one or more of data or control information.

Additionally, the NE 1100 may be configured to or operable to support any one or combination of modulating the modulated signal into a time-domain sequence of complex values based at least in part on one or more ADC steps supported by the first radio node; further including: transmitting third configuration information for reception of reference signal; and transmitting one or more first reference signals based at least in part on the third configuration information; the third configuration information includes an indication of one or more of channel inversion or pre-equalization applied at the NE; the one or more low-resolution receive behaviors of the NE are associated with a low resolution ADC of the NE.

Additionally, or alternatively, the NE 1100 may support at least one memory (e.g., the memory 1104) and at least one processor (e.g., the processor 1102) coupled with the at least one memory and configured to cause the NE to transmit first configuration information including one or more low-resolution receive behaviors of the NE; receive second configuration information for reception of a modulated signal, wherein the second configuration information is based at least in part on the first configuration information; and receive, based at least in part on the second configuration information, the modulated signal including one or more of data or control information.

Additionally, the NE 1100 may be configured to support any one or combination of where the one or more low-resolution receive behaviors of the NE are associated with a low resolution ADC of the NE; the at least one processor is configured to cause the NE to: receive third configuration information for reception of a reference signal; and receive one or more first reference signals based at least in part on the third configuration information; the one or more first reference signals include one or more reference signal values indicated to be measurable at a receiver of the NE; the one or more first reference signals are defined at one or more of an input stage of an ADC of the NE or an output stage of the ADC of the NE; the third configuration information includes an indication of one or more of channel inversion or pre-equalization, and wherein the at least one processor is configured to cause the NE to determine whether the one or more of the channel inversion or the pre-equalization is executable within an indicated error measure; based at least in part on receiving the one or more first reference signals, the at least one processor is configured to cause the NE to one or more of: perform measurement of the one or more first reference signals; report the performed measurement; or transmit one or more second reference signals with one or more transmission parameters quasi-co-located with the one or more first reference signals; the at least one processor is configured to cause the NE to one or more of: receive the third configuration information based at least in part on transmission of the first configuration information; or receive the third configuration information subsequent to transmission of the first configuration information.

Additionally, the NE 1100 may be configured to support any one or combination of where the third configuration information includes an indication of a predefined reference signal and an indication of one or more of a channel inversion or pre-equalization applied to the predefined reference signal; the third configuration information includes a definition of the one or more first reference signals in a time domain including an indication of a time-domain sequence of complex values at one or more of an input stage or an output stage of an ADC of the NE; the at least one processor is configured to cause the NE to one or more of: transmit an indication of a compatibility of the one or more first reference signals; adjust one or more parameters of the one or more first reference signals and report one or more adjusted parameters of the one or more first reference signals; or assume the one or more adjusted parameters of the one or more first reference signals in association with reporting the one or more adjusted parameters of the one or more first reference signals; the at least one processor is configured to cause the NE to adjust demodulation of the modulated signal received in association with the one or more first reference signals; the first configuration information includes one or more of: a baseband analog function computation capability indication associated with the NE; a programmable ADC resolution; or an association of the one or more low-resolution receive behaviors of the NE with one or more low-resolution transmit behaviors of the NE.

Additionally, or alternatively, the NE 1100 may support at least one memory (e.g., the memory 1104) and at least one processor (e.g., the processor 1102) coupled with the at least one memory and configured to cause the NE to receive first configuration information including one or more low-resolution receive behaviors of a first radio node; transmit second configuration information for reception of a modulated signal, wherein the second configuration information is based at least in part on the first configuration information; and transmit, based at least in part on the second configuration information, the modulated signal including one or more of data or control information.

Additionally, the NE 1100 may be configured to support any one or combination of where the at least one processor is configured to cause the NE to modulate the modulated signal into a time-domain sequence of complex values based at least in part on one or more ADC steps supported by the first radio node; the at least one processor is configured to cause the NE to: transmit third configuration information for reception of reference signal; and transmit one or more first reference signals based at least in part on the third configuration information; the third configuration information includes an indication of one or more of channel inversion or pre-equalization applied at the NE; the one or more low-resolution receive behaviors of the first radio node are associated with a low resolution ADC of the first radio node.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

In the context of a first radio node and a second radio node (e.g., interchangeably a UE and/or NE), implementations described herein can include a first radio node for wireless communication, including: at least one memory; and at least one processor coupled with the at least one memory and configured to cause the first radio node to: transmit first configuration information including one or more low-resolution receive behaviors of the first radio node; receive second configuration information for reception of a modulated signal, wherein the second configuration information is based at least in part on the first configuration information; and receive, based at least in part on the second configuration information, the modulated signal including one or more of data or control information.

Further, the one or more low-resolution receive behaviors of the first radio node are associated with a low resolution ADC of the first radio node; the at least one processor is configured to cause the first radio node to: receive third configuration information for reception of a reference signal; and receive one or more first reference signals based at least in part on the third configuration information; the one or more first reference signals include one or more reference signal values indicated to be measurable at a receiver of the first radio node; the one or more first reference signals are defined at one or more of an input stage of an ADC of the first radio node or an output stage of the ADC of the first radio node; the third configuration information includes an indication of one or more of channel inversion or pre-equalization, and wherein the at least one processor is configured to cause the first radio node to determine whether the one or more of the channel inversion or the pre-equalization is executable within an indicated error measure; based at least in part on receiving the one or more first reference signals, the at least one processor is configured to cause the first radio node to one or more of: perform measurement of the one or more first reference signals; report the performed measurement; or transmit one or more second reference signals with one or more transmission parameters quasi-co-located with the one or more first reference signals; the at least one processor is configured to cause the first radio node to one or more of: receive the third configuration information based at least in part on transmission of the first configuration information; or receive the third configuration information subsequent to transmission of the first configuration information.

Further, the third configuration information includes an indication of a predefined reference signal and an indication of one or more of a channel inversion or pre-equalization applied to the predefined reference signal; the third configuration information includes a definition of the one or more first reference signals in a time domain including an indication of a time-domain sequence of complex values at one or more of an input stage or an output stage of an ADC of the first radio node; the at least one processor is configured to cause the first radio node to one or more of: transmit an indication of a compatibility of the one or more first reference signals; adjust one or more parameters of the one or more first reference signals and report one or more adjusted parameters of the one or more first reference signals; or assume the one or more adjusted parameters of the one or more first reference signals in association with reporting the one or more adjusted parameters of the one or more first reference signals; the at least one processor is configured to cause the first radio node to adjust demodulation of the modulated signal received in association with the one or more first reference signals; the first configuration information includes one or more of: a baseband analog function computation capability indication associated with the first radio node; a programmable ADC resolution; or an association of the one or more low-resolution receive behaviors of the first radio node with one or more low-resolution transmit behaviors of the first radio node.

In implementations, the techniques described herein relate to a second radio node for wireless communication, including: at least one memory; and at least one processor coupled with the at least one memory and configured to cause the second radio node to: receive first configuration information including one or more low-resolution receive behaviors of a first radio node; transmit second configuration information for reception of a modulated signal, wherein the second configuration information is based at least in part on the first configuration information; and transmit, based at least in part on the second configuration information, the modulated signal including one or more of data or control information.

Further, at least one processor is configured to cause the second radio node to modulate the modulated signal into a time-domain sequence of complex values based at least in part on one or more ADC steps supported by the first radio node; the at least one processor is configured to cause the second radio node to: transmit third configuration information for reception of reference signal; and transmit one or more first reference signals based at least in part on the third configuration information; the third configuration information includes an indication of one or more of channel inversion or pre-equalization applied at the second radio node; the one or more low-resolution receive behaviors of the first radio node are associated with a low resolution ADC of the first radio node.

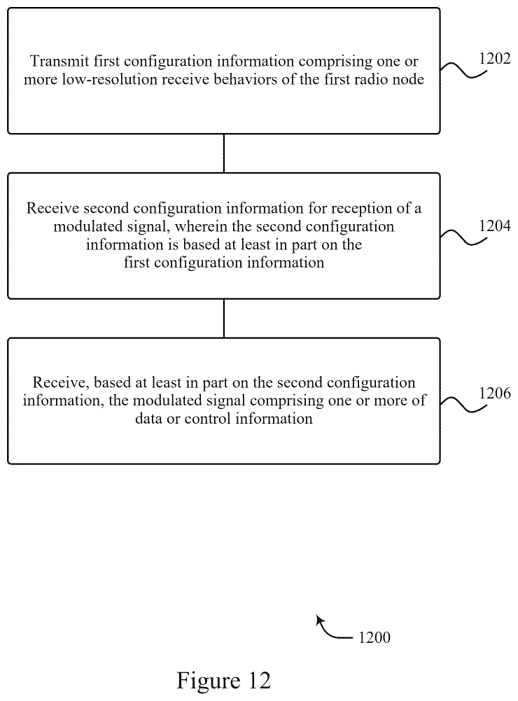

FIG. 12 illustrates a flowchart of a method 1200 in accordance with aspects of the present disclosure. The operations of the method may be implemented by a UE, processor, and/or an NE as described herein. In some implementations, the UE, processor, and/or NE may execute a set of instructions to control the function elements of the UE, processor, and/or NE to perform the described functions. It should be noted that the method described herein describes a possible implementation, and that the operations and the steps may be rearranged or otherwise modified and that other implementations are possible.

At 1202, the method may include transmitting first configuration information comprising one or more low-resolution receive behaviors of the first radio node. The operations of 1202 may be performed in accordance with examples as described herein. In some implementations, aspects of the operations of 1202 may be performed by a UE as described with reference to FIG. 9, a processor as described with reference to FIG. 10, and/or a NE as described with reference to FIG. 11.

At 1204, the method may include receiving second configuration information for reception of a modulated signal, wherein the second configuration information is based at least in part on the first configuration information. The operations of 1204 may be performed in accordance with examples as described herein. In some implementations, aspects of the operations of 1204 may be performed by a UE as described with reference to FIG. 9, a processor as described with reference to FIG. 10, and/or a NE as described with reference to FIG. 11.

At 1206, the method may include receiving, based at least in part on the second configuration information, the modulated signal comprising one or more of data or control information. The operations of 1206 may be performed in accordance with examples as described herein. In some implementations, aspects of the operations of 1206 may be performed by a UE as described with reference to FIG. 9, a processor as described with reference to FIG. 10, and/or a NE as described with reference to FIG. 11.

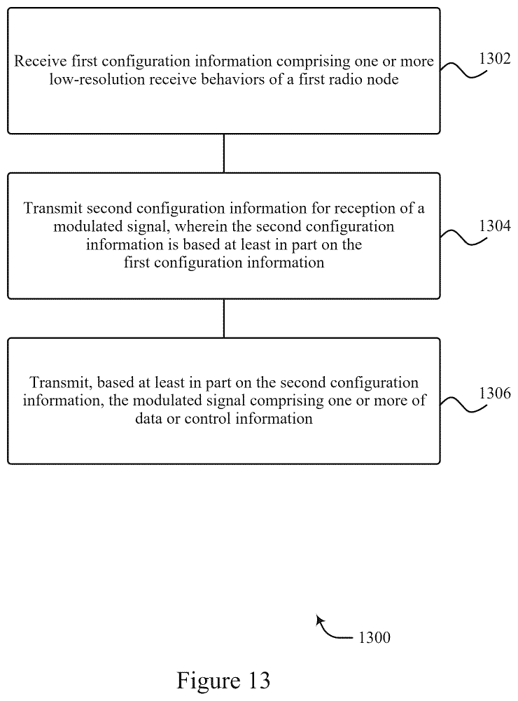

FIG. 13 illustrates a flowchart of a method 1300 in accordance with aspects of the present disclosure. The operations of the method may be implemented by a UE, processor, and/or an NE as described herein. In some implementations, the UE, processor, and/or NE may execute a set of instructions to control the function elements of the UE, processor, and/or NE to perform the described functions. It should be noted that the method described herein describes a possible implementation, and that the operations and the steps may be rearranged or otherwise modified and that other implementations are possible.

At 1302, the method may include receiving first configuration information comprising one or more low-resolution receive behaviors of a first radio node. The operations of 1302 may be performed in accordance with examples as described herein. In some implementations, aspects of the operations of 1302 may be performed by a UE as described with reference to FIG. 9, a processor as described with reference to FIG. 10, and/or a NE as described with reference to FIG. 11.

At 1304, the method may include transmitting second configuration information for reception of a modulated signal, wherein the second configuration information is based at least in part on the first configuration information. The operations of 1304 may be performed in accordance with examples as described herein. In some implementations, aspects of the operations of 1304 may be performed by a UE as described with reference to FIG. 9, a processor as described with reference to FIG. 10, and/or a NE as described with reference to FIG. 11.

At 1306, the method may include transmitting, based at least in part on the second configuration information, the modulated signal comprising one or more of data or control information. The operations of 1306 may be performed in accordance with examples as described herein. In some implementations, aspects of the operations of 1306 may be performed by a UE as described with reference to FIG. 9, a processor as described with reference to FIG. 10, and/or a NE as described with reference to FIG. 11.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first radio node for wireless communication, comprising:
at least one memory; and
at least one processor coupled with the at least one memory and configured to cause the first radio node to:
transmit first configuration information comprising one or more low-resolution receive behaviors of the first radio node;
receive second configuration information for reception of a modulated signal, wherein the second configuration information is based at least in part on the first configuration information; and
receive, based at least in part on the second configuration information, the modulated signal comprising one or more of data or control information.

2. The first radio node of claim 1, wherein the one or more low-resolution receive behaviors of the first radio node are associated with a low resolution analog-to-digital converter (ADC) of the first radio node.

3. The first radio node of claim 1, wherein the at least one processor is configured to cause the first radio node to:
receive third configuration information for reception of a reference signal; and
receive one or more first reference signals based at least in part on the third configuration information.

4. The first radio node of claim 3, wherein the one or more first reference signals comprise one or more reference signal values indicated to be measurable at a receiver of the first radio node.

5. The first radio node of claim 3, wherein the one or more first reference signals are defined at one or more of an input stage of an analog-to-digital converter (ADC) of the first radio node or an output stage of the ADC of the first radio node.

6. The first radio node of claim 3, wherein the third configuration information comprises an indication of one or more of channel inversion or pre-equalization, and wherein the at least one processor is configured to cause the first radio node to determine whether the one or more of the channel inversion or the pre-equalization is executable within an indicated error measure.

7. The first radio node of claim 3, wherein based at least in part on receiving the one or more first reference signals, the at least one processor is configured to cause the first radio node to one or more of:
perform measurement of the one or more first reference signals;
report the performed measurement; or
transmit one or more second reference signals with one or more transmission parameters quasi-co-located with the one or more first reference signals.

8. The first radio node of claim 3, wherein the at least one processor is configured to cause the first radio node to one or more of:
receive the third configuration information based at least in part on transmission of the first configuration information; or
receive the third configuration information subsequent to transmission of the first configuration information.

9. The first radio node of claim 3, wherein the third configuration information comprises an indication of a predefined reference signal and an indication of one or more of a channel inversion or pre-equalization applied to the predefined reference signal.

10. The first radio node of claim 3, wherein the third configuration information comprises a definition of the one or more first reference signals in a time domain including an indication of a time-domain sequence of complex values at one or more of an input stage or an output stage of an analog-to-digital converter (ADC) of the first radio node.

11. The first radio node of claim 3, wherein the at least one processor is configured to cause the first radio node to one or more of:
transmit an indication of a compatibility of the one or more first reference signals;
adjust one or more parameters of the one or more first reference signals and report one or more adjusted parameters of the one or more first reference signals; or
assume the one or more adjusted parameters of the one or more first reference signals in association with reporting the one or more adjusted parameters of the one or more first reference signals.

12. The first radio node of claim 3, wherein the at least one processor is configured to cause the first radio node to adjust demodulation of the modulated signal received in association with the one or more first reference signals.

13. The first radio node of claim 1, wherein the first configuration information comprises one or more of:
a baseband analog function computation capability indication associated with the first radio node;
a programmable analog-to-digital converter (ADC) resolution; or
an association of the one or more low-resolution receive behaviors of the first radio node with one or more low-resolution transmit behaviors of the first radio node.

14. A second radio node for wireless communication, comprising:
at least one memory; and
at least one processor coupled with the at least one memory and configured to cause the second radio node to:
receive first configuration information comprising one or more low-resolution receive behaviors of a first radio node;
transmit second configuration information for reception of a modulated signal, wherein the second configuration information is based at least in part on the first configuration information; and
transmit, based at least in part on the second configuration information, the modulated signal comprising one or more of data or control information.

15. The second radio node of claim 14, wherein the at least one processor is configured to cause the second radio node to modulate the modulated signal into a time-domain sequence of complex values based at least in part on one or more analog-to-digital converter (ADC) steps supported by the first radio node.

16. The second radio node of claim 14, wherein the at least one processor is configured to cause the second radio node to:
transmit third configuration information for reception of reference signal; and
transmit one or more first reference signals based at least in part on the third configuration information.

17. The second radio node of claim 16, wherein the third configuration information comprises an indication of one or more of channel inversion or pre-equalization applied at the second radio node.

18. The second radio node of claim 14, wherein the one or more low-resolution receive behaviors of the first radio node are associated with a low resolution analog-to-digital converter (ADC) of the first radio node.

19. A processor for wireless communication, comprising:
at least one controller coupled with at least one memory and configured to cause the processor to:
transmit first configuration information comprising one or more low-resolution receive behaviors of a first radio node;
receive second configuration information for reception of a modulated signal, wherein the second configuration information is based at least in part on the first configuration information; and
receive, based at least in part on the second configuration information, the modulated signal comprising one or more of data or control information.

20. A processor for wireless communication, comprising:
at least one controller coupled with at least one memory and configured to cause the processor to:
receive first configuration information comprising one or more low-resolution receive behaviors of a first radio node;
transmit second configuration information for reception of a modulated signal, wherein the second configuration information is based at least in part on the first configuration information; and
transmit, based at least in part on the second configuration information, the modulated signal comprising one or more of data or control information.
